(19) United States
(12) Patent Application Publication
(10) Pub. No.: US 2010/0127143 A1
(43) Pub. Date: May 27, 2010

(54) KEYBOARD SUPPORT

(76) Inventor: Daniel David Karmazyn, Thornhill (CA)

Correspondence Address: HARNESS, DICKEY & PIERCE, P.L.C., P.O. BOX 828, BLOOMFIELD HILLS, MI, 48303, US

(21) Appl. No.: 12/596,109

(22) PCT Filed: Apr. 16, 2008
(86) PCT No.: PCT/CA2008/000704

§ 371 Date: Jan. 27, 2010

(30) Foreign Application Priority Data
Nov. 28, 2007 (CA) 2,612,696
Nov. 28, 2007 (CA) 2,612,817

(51) Int. Cl. F16M 13/00

(52) U.S. Cl. 248/224.8; 248/220.21

(57) ABSTRACT

There is provided A keyboard-keyboard support combination comprising: a keyboard including a keyboard housing; a keyboard support including a support surface, wherein the support surface is configured for supporting the keyboard; an engagement tab projecting from one of the keyboard and the keyboard support; and an engagement surface provided on the other one of the keyboard and the keyboard support; wherein the engagement tab is configured to co-operate with the engagement surface so that the engagement surface opposes movement of the engagement tab relative to the keyboard support when the keyboard is supported on the keyboard support.

### FIELD OF THE INVENTION

The present invention relates to keyboards and keyboard support devices.

### BACKGROUND OF THE INVENTION

Existing keyboard trays are provided to support keyboard devices at workstations. However, the design of existing keyboard designs do not facilitate ergonomically favourable conditions for using keyboards.

### SUMMARY OF THE INVENTION

In one aspect there is provided a keyboard-keyboard support combination comprising: a keyboard including a keyboard housing; a keyboard support including a support surface, wherein the support surface is configured for supporting the keyboard; an engagement tab projecting from one of the keyboard and the keyboard support; and an engagement surface provided on the other one of the keyboard and the keyboard support; wherein the engagement tab is configured to co-operate with the engagement surface so that the engagement surface opposes movement of the engagement tab relative to the keyboard support when the keyboard is supported on the keyboard support.

In a further aspect there is provided a keyboard-keyboard support combination comprising: a keyboard; and a keyboard support; wherein the keyboard is configured to be coupled to the keyboard support by way of snap-fit engagement.

In a further aspect there is provided a keyboard comprising: a key section including a plurality of data input keys; a mousepad section including a mousepad surface; and a mouse retainer disposed peripherally relative to the mousepad surface; such that, when a mouse device is disposed on a portion of the mousepad surface, and the portion of the mousepad surface is substantially horizontal, and the keyboard is then re-positioned so that the portion of the mousepad surface becomes disposed at a sufficient angle relative to the horizontal such that gravitational force effects movement of the mouse device, the mouse device is prevented from sliding off the keyboard by the mouse retainer.

In a further aspect there is provided a keyboard-keyboard support combination, wherein the keyboard is supported by the keyboard support, comprising: a QWERTY key area including at least 50 keys; and a mousepad surface; wherein the maximum width of the keyboard support is less than about 19 inches.

In a further aspect there is provided a keyboard support configured for receiving and attaching to a mounting plate of a mounting plate of a keyboard mounting mechanism, comprising a recessed mounting surface corresponding to the mounting plate of the keyboard mounting mechanism, wherein the recessed mounting surface is configured to receive the mounting plate and effect coupling of the mounting plate to the mounting surface.

In a further aspect there is provided a workstation assembly comprising: a workstation; a keyboard support coupled to the workstation; a keyboard including a housing, wherein the keyboard is supported by and coupled to the keyboard support such that lateral movement of the keyboard housing relative to the keyboard support is thereby opposed, and further including: a QWERTY key arrangement including at least 50 keys; and a mousepad surface; wherein the minimum horizontal distance between: (i) the space between the “G” and “H” keys, and (ii) a vertical plane tangent to an edge of the mousepad surface closest to the key, is from about 5 inches to about 10 inches.

In a further aspect there is provided a keyboard support comprising: a plastic support assembly, including a support surface configured for supporting a keyboard; a ballast assembly including at least one ballast, wherein each of the one ballast is coupled to the plastic support assembly, wherein the keyboard support includes at least 25 weight percent of the at least one ballast based on the total weight of the keyboard support; and wherein the ballast assembly is provided to contribute additional weight to the keyboard support.

In a further aspect there is provided a A keyboard-keyboard support combination comprising: a keyboard support; a keyboard supported on the keyboard support; wherein the maximum thickness of the combination of the keyboard and the keyboard support is less than about 2 inches.

### BRIEF DESCRIPTION OF THE DRAWINGS

FIG. 1 is a bottom plan view of an embodiment of a combination of a keyboard coupled to a keyboard support;

FIG. 2 is a front elevation view of the keyboard support illustrated in FIG. 1;

FIG. 3 is a side elevation view of the keyboard support illustrated in FIG. 1;

FIG. 4 is a fragmentary bottom front perspective view of the keyboard support illustrated in FIG. 1;

FIG. 5 is a top plan view of the keyboard support illustrated in FIG. 1;

FIG. 6 is a fragmentary top front perspective view of the keyboard support illustrated in FIG. 1, illustrating a rear section of the keyboard support including a retaining tab;

FIG. 7 is a fragmentary top rear perspective view of the combination illustrated in FIG. 1, illustrating the coupling of the retaining tab, more particularly illustrated in FIG. 6, to a keyboard, and illustrating an engagement tab received within a receiving well;

FIG. 8 is a fragmentary sectional side elevation view of the combination illustrated in FIG. 1, illustrating the coupling of the retaining tab, more particularly illustrated in FIG. 6, to a rear of the keyboard;

FIG. 9 is a fragmentary top front perspective view of the keyboard support illustrated in FIG. 1, illustrating a retaining tab and a receiving well at a front corner edge of the keyboard support;

FIG. 10 is a fragmentary top front perspective view of the combination illustrated in FIG. 1, illustrating the coupling of a retaining tab to a recess provided in a front portion of the keyboard;

FIG. 11 is a fragmentary sectional side elevation view of the combination illustrated in FIG. 1 of the same side as the fragment of which is illustrated in FIG. 8, illustrating the coupling of a retaining tab, disposed proximate to the front of the keyboard support, to the keyboard;

FIG. 12 is top plan view of the combination illustrated in FIG. 1 coupled to a multi-position adjustable keyboard supporting mechanism;

FIG. 13 is a fragmentary top front perspective view of the keyboard support illustrated in FIG. 1, illustrating a front portion of the keyboard support including a receiving well;

FIG. 14 is a fragmentary top perspective view of the combination illustrated in FIG. 1, illustrating the coupling of a retaining tab to a recess disposed at the front of the keyboard support;

FIG. 15 is a fragmentary sectional side elevation view of the combination illustrated in FIG. 1 of a side opposite to the side whose fragments are illustrated in FIGS. 8 and 11, illustrating a receiving well, disposed at a front portion of the keyboard support, receiving an engagement tab;

FIG. 16 is a top front perspective view of the combination illustrated in FIG. 1 coupled to a multi-position adjustable keyboard supporting mechanism;

FIG. 17 is a rear elevation view of the combination illustrated in FIG. 1;

FIG. 18 is front sectional side elevation view of the combination illustrated in FIG. 1;

FIG. 19 is a side elevation view of the combination illustrated in FIG. 1 coupled to a multi-position adjustable keyboard supporting mechanism;

FIG. 20 is a bottom front perspective view of the combination illustrated in FIG. 1 coupled to a multi-position adjustable keyboard supporting mechanism;

FIG. 21 is a top front perspective view of the multi-position adjustable keyboard supporting mechanism;

FIG. 22 is an exploded bottom front perspective view of a combination of the keyboard, keyboard support, and the multi-position adjustable keyboard supporting mechanism;

FIG. 23 is a fragmentary top front perspective view of a rear portion of the keyboard illustrated in FIG. 1, including illustration of the mouse retainer;

FIG. 24 is an exploded fragmentary top perspective view of a rear portion of the keyboard illustrated in FIG. 1, including illustration of the mouse retainer, taken from a perspective opposite to that from which the view in FIG. 23 is taken;

FIG. 25 is a fragmentary top front perspective view of a mousepad section of the combination illustrated in FIG. 1, including illustration of a mouse device disposed on a mousepad surface;

FIG. 26 is a top plan view of a human positioned at a workstation and using a keyboard and mouse device on a mousepad, wherein the keyboard and mousepad are supported on a conventional tray;

FIG. 27 is a top plan view of a human positioned at a workstation and using a keyboard and keyboard support combination illustrated in FIG. 1;

FIG. 28 is a top plan view of a human positioned at a corner desk configuration of a workstation and using a keyboard and mouse device on a mousepad, wherein the keyboard and mousepad are supported on a conventional tray;

FIG. 29 is a top plan view of a human positioned at a corner desk configuration of a workstation and using a keyboard and keyboard support combination illustrated in FIG. 1;

FIG. 30 is a side elevation view of a human positioned at a corner desk configuration of a workstation and using a keyboard and mouse device on a mousepad, wherein the keyboard and mousepad are supported on a conventional tray;

FIG. 31 is a side elevation view of of a human positioned at a workstation and using a keyboard and keyboard support combination illustrated in FIG. 1;

FIG. 32 is an exploded front elevation view of the combination illustrated in FIG. 1, including illustration of how certain elements of the keyboard are received by the keyboard support;

FIG. 33 is an exploded rear elevation view of the combination illustrated in FIG. 1, including illustration of how certain elements of the keyboard are received by the keyboard support;

FIG. 34 is a fragmentary sectional side elevation view of the combination illustrated in FIG. 1, illustrating the retaining tab in a first position prior to coupling to a rear of the keyboard, and in a second position after having become disposed in a snap-fit relationship within a recess at the rear of the keyboard;

FIGS. 35 to 37 are sectional side elevation views of the combination illustrated in FIG. 1, illustrating steps by which the keyboard becomes coupled to the keyboard support;

FIG. 38 is a fragmentary sectional side elevation view of the combination illustrated in FIG. 1, illustrating an intermediate step in effecting coupling of the keyboard to the keyboard support, and particularly illustrating the guiding of the keyboard towards a position for effecting alignment between the keyboard recess and a rear retainer tab; and

FIG. 39 is a side elevation view of another embodiment of a keyboard.

### DETAILED DESCRIPTION OF THE PREFERRED EMBODIMENTS

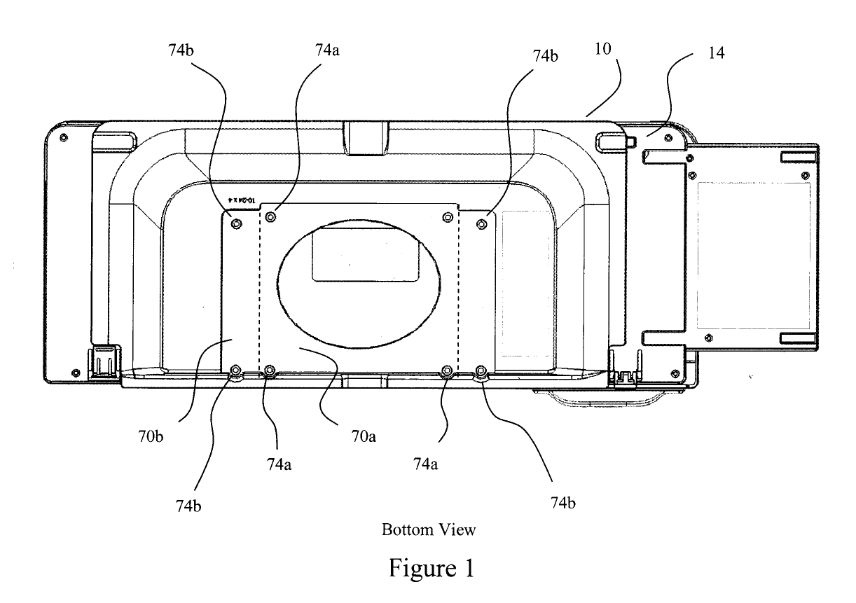

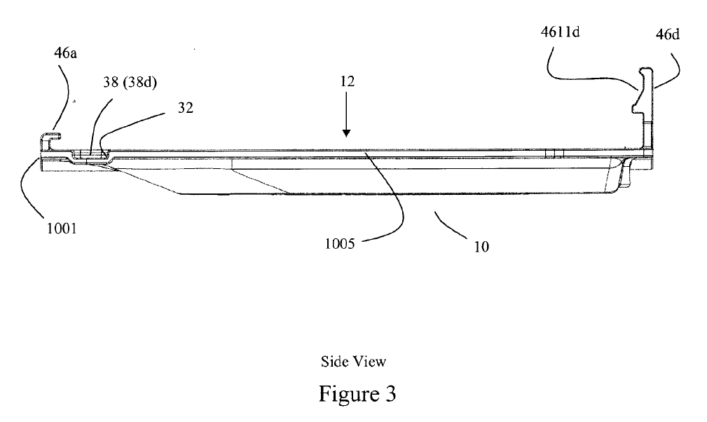

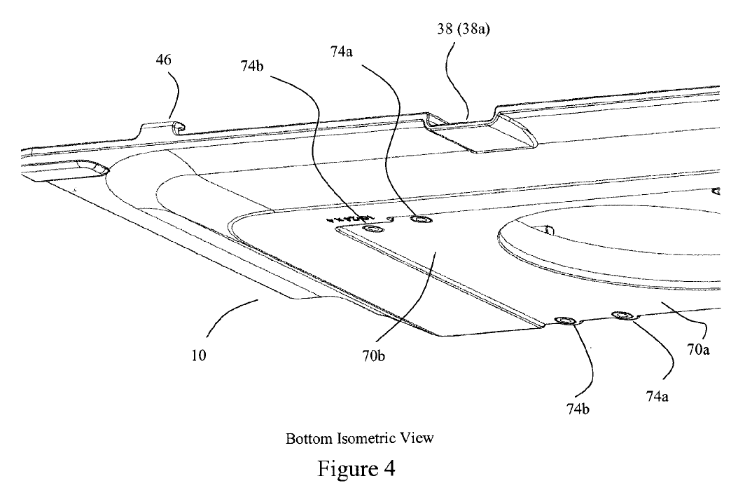

Referring to FIGS. 1 to 5, there is provided a keyboard support 10 including a support surface 12. The support surface 12 is configured for supporting a keyboard 14. For example, with respect to the support surface 12, the support surface 12 is configured to provide vertical support to the keyboard 14. For example, the keyboard support includes a front 1001, a rear 1003, and opposite sides 1005, 10007.

For example, the keyboard support is plastic and is manufactured by injection moulding. For example, suitable plastics include high impact polystyrene, PA6-Nylon, or fibre reinforce ABS (acrylonitrile butadiene styrene) polymer.

For example, the keyboard 14 is coupled to the keyboard support 10 such that the keyboard 14 and keyboard support 10 is a coupled unit. The keyboard includes a front 1401, a rear 1403, and opposite sides 1405, 1407.

For example, a suitable keyboard for integration with at least some of the described aspects herein is the Jasper freeBOARD™ distributed by 2057367 Ontario Limited o/a Jasper Designworks, Toronto, Ontario (www.jasperd.com). A further example of a suitable keyboard for integration with at least some of the described aspects herein is disclosed in International patent application no. PCT/CA2006/000289 (published as International publication no. WO/2006/099714 A1). In this respect, an example of a suitable keyboard is a keyboard including an integrated mousepad. Also in this respect, an example of a suitable keyboard is a keyboard including a retractable numeric keypad which is configured to nest within a cavity provided in the keyboard housing.

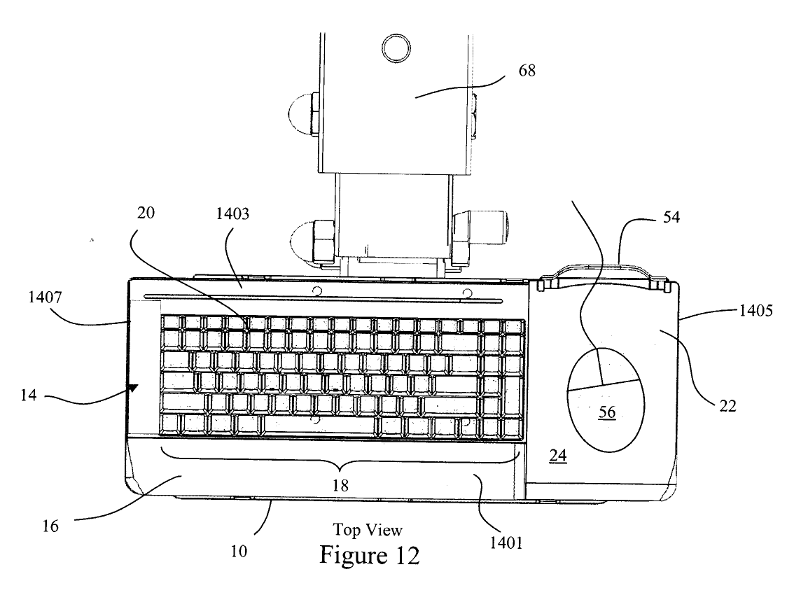

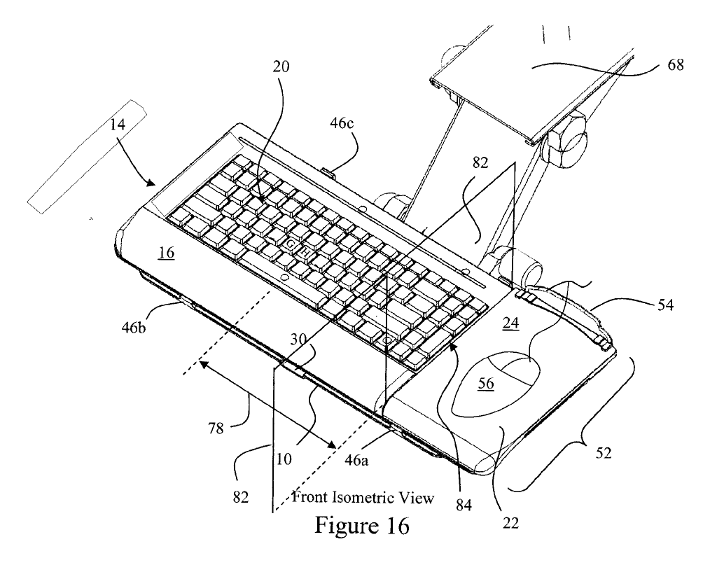

Referring to FIGS. 12 and 16, the keyboard 14 includes a housing 16 and a key area 20. The keyboard housing 16 includes an upper surface from which the key area 20 is accessible.

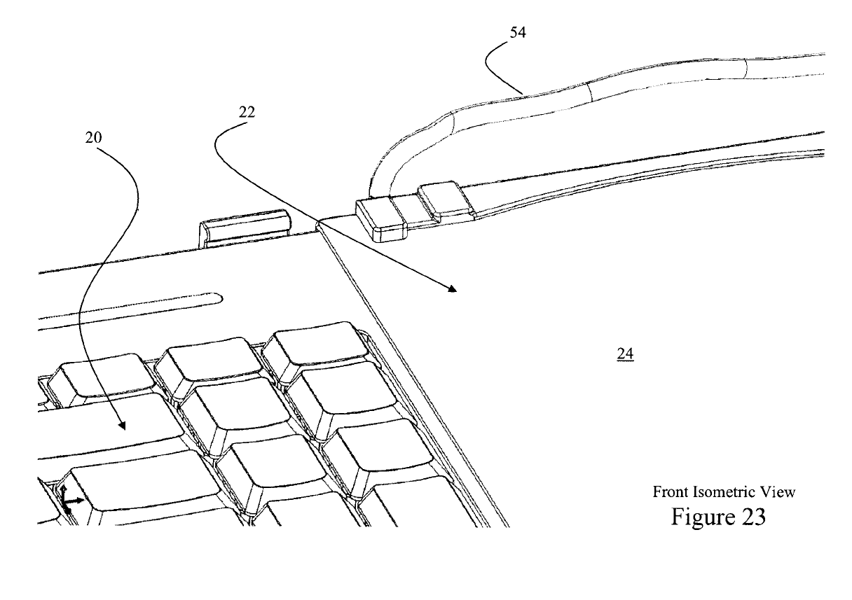

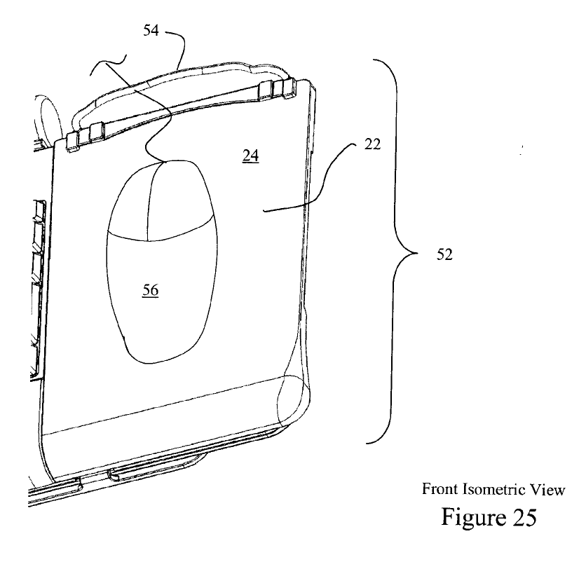

For example, and referring to FIGS. 16, 23, 24, and 25, the keyboard 14 includes an integrated mousepad 22, wherein the mousepad 22 merges with the housing 16.

For example, the keyboard housing 16 is injection moulded plastic. For example, a suitable plastic is high impact polystyrene. For example, with respect to the key area, the key area is a QWERTY key area including at least 50 keys. For example, with respect to each of the keys of the QWERTY key area, each of the keys includes a minimum width of at least about 0.4 inches. For example, the minimum width is about 0.71 inches.

The keyboard support 10 and keyboard housing 16 are co-operatively configured such that movement of the keyboard housing 16 is opposed when the keyboard 14 is supported on the support surface 12. For example, the keyboard support 10 is configured to oppose lateral movement of the keyboard housing 16 relative to the keyboard support 10. As a further example, the keyboard support 10 is configured to oppose movement of the keyboard housing 16 relative to a support surface reference axis defined by an axis 200 which is normal to a plane 202 tangent to at least a portion of the support surface 12, when the keyboard 14 is supported on the support surface 12. As a further example, The keyboard support 10 is also configured to oppose movement of the keyboard 14 when the keyboard 14 is supported on the support surface 12. For example, the keyboard support 10 is configured to oppose lateral movement of the keyboard 14 relative to the keyboard support 10. As a further example, the keyboard support 10 is configured to oppose movement of the keyboard 14 relative to a support surface reference axis defined by the axis 200 which is normal to the plane 202 tangent to at least a portion of the support surface 12, when the keyboard 14 is supported on the support surface 12. As a further example, the keyboard support 12 is configured to oppose movement of the keyboard housing 16 which would be effected by an application of force to the keyboard 14 in a direction orthogonal to the support surface reference axis 200. For example, with respect to each of the above-described movements, each of the above-described movements is limited. As a further example, with respect to each of the above-described movements, each of the above-described movements is substantially prevented.

For example, with respect to the key area 20 is a QWERTY key area. For example, the QWERTY key area includes at least 50 keys. For example, with respect to each of the keys, each of the keys as a minimum width of at least about 0.4 inches. For example, with respect to each of the keys, each of the keys has a minimum width of about 0.71 inches.

As the term is used herein, the mousepad 22 refers to a substantially flat designated area suitable for operating a mouse device 56. For example, the mousepad surface 24 includes a surface area of at least 22 square inches. For example, the surface area is 36 square inches. For example, the mousepad surface 24 is manufactured from the same material as the keyboard housing. As a further option, a highly reflective veneer or film could be used to form the mousepad surface 24.

As the term is used herein, the mouse device 56 is an input device which is configured for movement in a substantially flat plane on a corresponding substantially flat surface (ie. the mousepad).

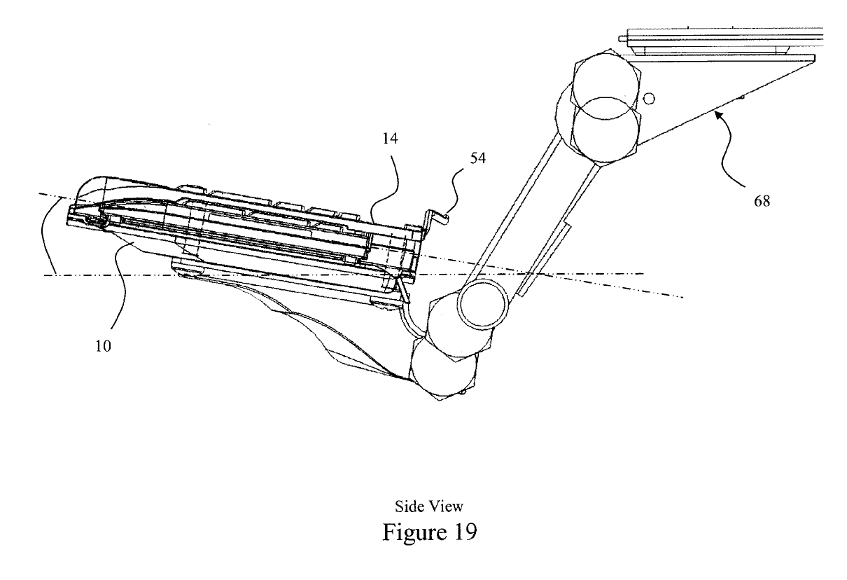

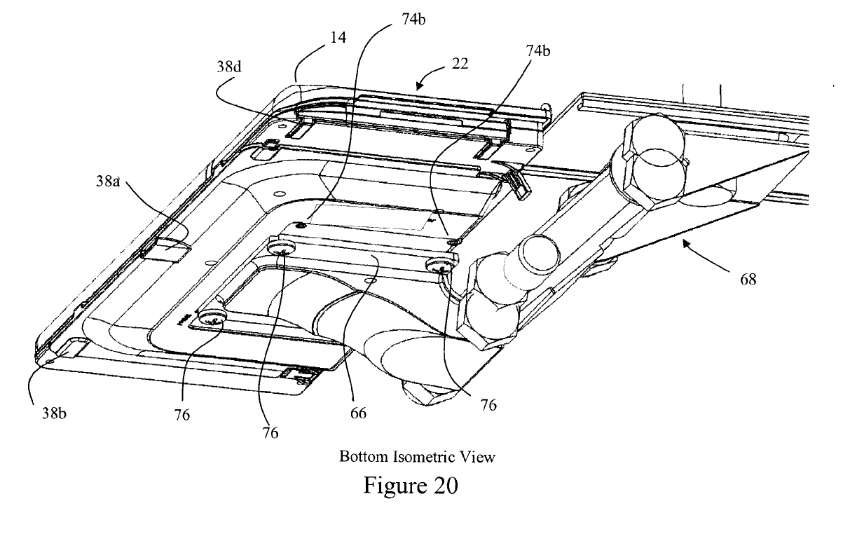

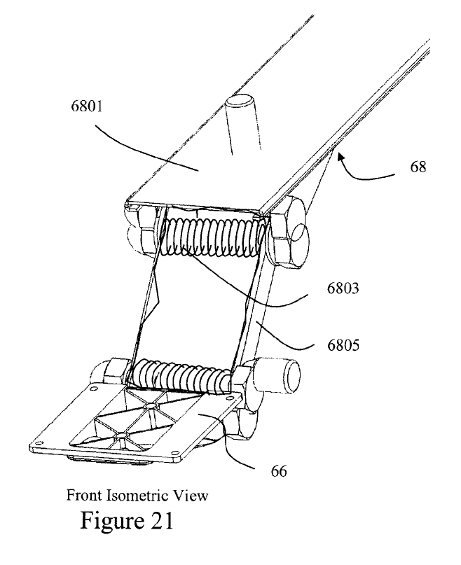

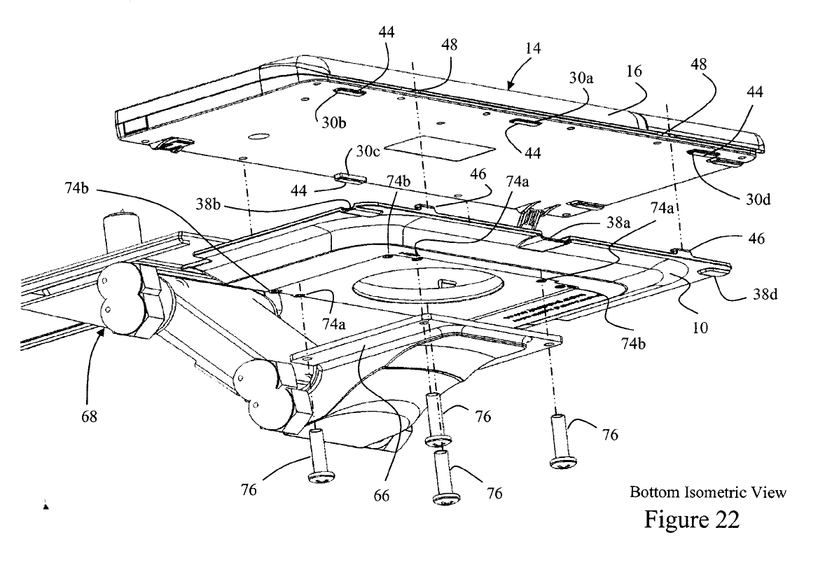

For example, the keyboard support 10 is coupled to a workstation 26 and supports the keyboard 14 to provide a workstation assembly 28. In this respect, for example, there is further provided a multi-position adjustable keyboard supporting mechanism 68 configured for attachment to the keyboard support 10. Referring to FIGS. 19 to 22, the mechanism 68 includes a mounting plate 66 configured for attachment to a mounting surface provided on the keyboard support 12. For example, the keyboard support includes two mounting surfaces 70a, 70b, wherein each of them is configured for receiving a mounting plate 68. For example, and referring to FIGS. 20 and 22, the mounting plate 68 can be attached to one of the mounting surfaces 70a or 70b with bolts 76. The mounting surface 70a includes apertures 74a, while the mounting surface includes apertures 74b, and the apertures 74a, 74b are configured to receive bolts 76 to effect coupling of the mounting plate 68 to one of the mounting surfaces 70a, 70b. The mechanism 68 also includes a fastening bolt 69 configured for attachment to a workstation 26. In this respect, when coupling of the keyboard support 10 to a workstation 26 is effected by the multi-position adjustable keyboard supporting mechanism 68, and the keyboard 14 is coupled to the keyboard support 10, there is provided a workstation assembly 28 including a workstation 26, a keyboard support 10 coupled to the workstation 26, and a keyboard 14 coupled to the keyboard support 10.

The multi-position adjustable keyboard supporting mechanism 68 includes a mounting plate 68 which is biased upwardly to support a predetermined range of weight within a range of vertical dispositions. In this respect, the mechanism 68 includes a spring 6803 coupled at one end to a bracket located directly underneath a rail 6801. The rail 6801 facilitates sliding movement of the mounting plate 66 forwardly and rearwardly relatively to the workstation 26, when the mechanism 68 is coupled to the workstation 26. The other end of the spring 6803 to an element 6805 and thereby transmit a biasing force to counteract weight being applied to the mounting plate 66. Insufficient weight acting on the mounting plate 66 may cause the mounting plate 66 to inadvertently “jump up”.

Examples of suitable multi-position adjustable keyboard supporting mechanism 68 include Humanscale™ Model 5G keyboard support mechanism, Anatome™ Model CA300HG, Anatome™ Model CA200,Anatome™ Model CA100, or Anatome™ Model WallTrax #1602.

For example, with respect to the workstation 26, the workstation 26 can assume any configuration know in the industry, and the workstation 26 includes a desk 27.

### (A) First Mode of Co-Operative Configuration of Keyboard and Keyboard Support for Opposing Movement of Keyboard Relative to Keyboard Support

A mode of the co-operative configuration of the keyboard 14 and the keyboard support 10 is provided.

The keyboard 14 includes the keyboard housing 16, and the keyboard housing 16 includes an engagement tab 30.

The keyboard support 10 includes the support surface 12.

### First Aspect

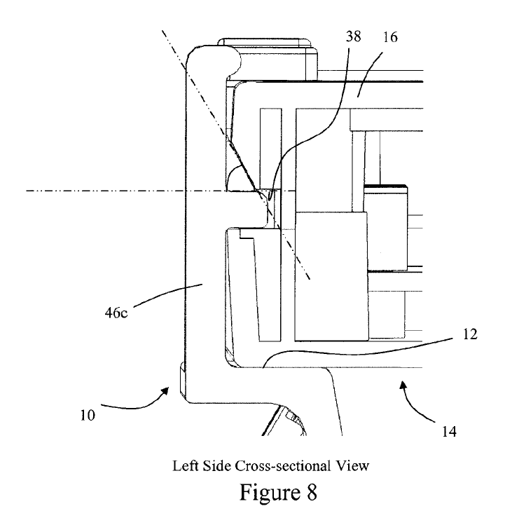

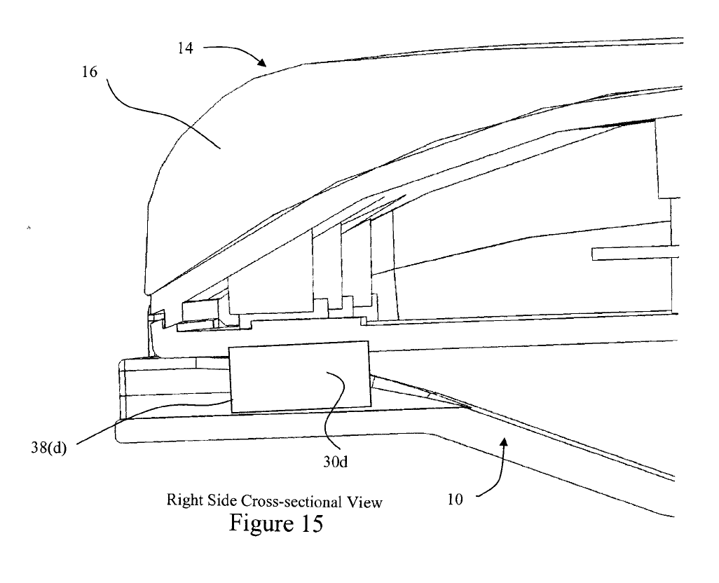

Referring to FIGS. 8, 13, 15, 32, and 33, in one aspect, an engagement tab 30 is further provided projecting from one of the keyboard 14 and the keyboard support 10. An engagement surface 32 is also provided on the other one of the keyboard 14 and the keyboard support 10. The engagement tab 30 is configured to co-operate with the engagement surface 32 so that the engagement surface 32 opposes movement of the engagement tab 30 when the keyboard 14 is supported on the keyboard support 10.

For example, with respect to the engagement tab 30, the engagement tab 30 extends across a reference plane 202 which is tangent to a portion of the support surface of the keyboard support 10.

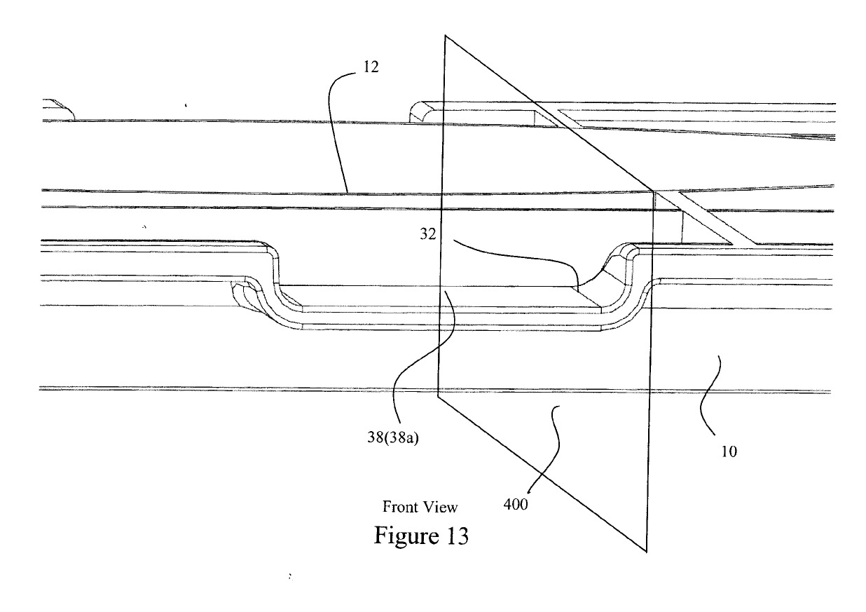

For example, and referring to FIG. 13, with respect to the engagement surface 32, an engagement surface reference plane is defined by a plane 400 tangent to the engagement surface 32, and the engagement surface reference plane traverses a horizontal plane when the keyboard 14 is supported on the keyboard support 12. As a further example with respect to the engagement surface 32, the engagement surface 32 is configured to be disposed in opposition to the engagement tab 30 when the keyboard 14 is supported on the keyboard support 10. As a further example with respect to the engagement surface 32, the engagement surface 32 includes a minimum surface area of at least about 0.03 square inches. For example, the minimum surface area is 0.05 square inches.

For example, with respect to the co-operation between the engagement tab 30 and the engagement surface 32, the engagement tab 30 is configured to co-operate with the engagement surface 32 so that the engagement surface 32 opposes movement of the engagement tab 30 and thereby opposes lateral movement of the keyboard housing 16 relative to the keyboard support surface 10, when the keyboard 14 is supported on the keyboard support surface 10. For example, with respect to the lateral movement being opposed, the lateral movement being opposed is that movement which would be lateral relative to the support surface reference axis 200. For example, with respect to the lateral movement being opposed, the lateral movement being opposed is sideways movement. For example, with respect to the lateral movement being opposed, the lateral movement being opposed is that movement which would be effected by an application of force to the keyboard in a direction orthogonal to the support surface reference axis 200.

As a further example with respect to the co-operation between the engagement tab 30 and the engagement surface 32, the engagement tab 30 is configured to co-operate with the engagement surface 32 such that the engagement surface 32 opposes movement of the engagement tab 30 and thereby opposes movement of the keyboard housing 16 relative to the support surface reference axis 200 when the keyboard is supported on the support surface.

As a further example with respect to the co-operation between the engagement tab 30 and the engagement surface 32, the engagement tab 30 is configured to co-operate with the engagement surface 32 such that the engagement surface 32 opposes movement of the engagement tab 30 which would be effected by an application of force to the keyboard in a direction orthogonal to the support surface reference axis 200, when the keyboard is supported on the support surface.

For example, with respect to the configured disposition of the engagement tab 30 relative to the engagement surface 32, the engagement tab 30 is configured to be disposed in an interference fit relationship with the engagement surface 32 when the keyboard 14 is supported on the keyboard support 10. As a further example with respect to the configured disposition of the engagement tab 30 relative to the engagement surface 32, the engagement tab 30 is configured to be disposed in a snap-fit relationship with the engagement surface 32 when the keyboard 14 is supported on the keyboard support 10.

### Second Aspect

In another aspect of the co-operative configuration between keyboard 14 and the keyboard support 10, there is also provided a receiving well 38, and the receiving well 38 includes the above-described engagement surface 32 to effect the opposition to the movement of the keyboard housing 16 relative to the keyboard support 10. The receiving well is configured to receive the engagement tab when the keyboard is supported on the support surface.

### Third Aspect

A further aspect of the co-operative configuration between the keyboard 14 and the keyboard support 10 is also provided. In this aspect, there is provided an engagement tab assembly 40 and an engagement surface assembly 42. The engagement tab assembly 40 is configured to co-operate with the engagement surface assembly 42 such that the above-described opposition to the movement of the keyboard housing 16 relative to the keyboard support 10 is effected when the keyboard 14 is supported on the support surface 10.

For example, the engagement tab assembly 40 includes at least one engagement tab 30, and each one of the at least one engagement tab 30 projects from any one of the keyboard 14, the keyboard support 10, or a combination thereof The engagement surface assembly 42 includes at least one engagement surface 32. Each one of the at least one engagement surface 32 is configured to oppose movement of a respective one of the at least one engagement tab 30 relative to the other one of the keyboard 14 or the keyboard support 10 from which the respective one of the at least one engagement tab 30 projects, when the keyboard 14 is supported on the keyboard support 10.

For example, for each one of the at least one engagement tab 30 projects from the keyboard 14, the respective one of the at least one engagement surface 32 is provided in the keyboard support 10. For each one of the at least one engagement tab 30 projecting from the keyboard support 10, the respective one of the at least one engagement surface 32 is provided in the keyboard 14.

For example, each one of the at least one engagement tab 30 is projecting from the keyboard 14, and each one of the at least one engagement surface 32 is provided in the keyboard support 10.

For example, each one of the at least one engagement surface 32 is configured to receive a respective one of the at least one engagement tab 30 when the keyboard 14 is supported on the keyboard support 10 such that each one of the at least one engagement surface 32 is disposed in an interference fit relationship with the respective one of the at least one engagement tab 30.

### Fourth Aspect

A further aspect of the co-operative configuration between the keyboard 14 and the keyboard support 10 is also provided. In this aspect, there is provided an engagement tab assembly 40 and a receiving well assembly 41. The engagement tab assembly 40 is configured to co-operate with the receiving well assembly 41 such that the above-described opposition to the movement of the keyboard housing 16 relative to the keyboard support 10 is effected when the keyboard 14 is supported on the support surface 10.

For example, the engagement tab assembly 40 includes at least one engagement tab 40 projecting from any one of the keyboard 14, the keyboard support 10, or a combination thereof, and the receiving well assembly 41 includes at least one receiving well 38. Each one of the at least one receiving well 38 is configured to receive a respective at least one of the at least one engagement tab 40, such that each one of the at least one engagement tab 40 is configured to be received by a one of the at least one receiving well 38 when the keyboard 14 is supported on the keyboard support 10.

For example, for each one of the respective at least one of the at least one engagement tab 40 projecting from the keyboard 14 and configured to be received by a one of the at least one receiving well 38 when the keyboard 14 is supported on the keyboard support 10, the one of the at least one receiving well 38 is provided in the keyboard support 10. As well, for each one of the respective at least one of the at least one engagement tab 30 projecting from the keyboard support 10 and configured to be received by a one of the at least one receiving well 38 when the keyboard 14 is supported on the keyboard support 10, the one of the at least one receiving well 38 is provided in the keyboard 14.

For example, the at least one receiving well 38 is a plurality of receiving wells 38, and the at least one engagement tab 30 is a plurality of engagement tabs 30. In this respect, each one of the plurality of engagement tabs 30 corresponds to a respective one of the plurality of receiving wells 38, such that each one of plurality of engagement tabs 30 is configured to be received by the respective one of the plurality of receiving wells 38 when the keyboard 14 is supported on the keyboard support 10. For each one of the plurality of engagement tabs 30 projecting from the keyboard 14, the respective one of the plurality of receiving wells 38 is provided in the keyboard support 10. For each one of the plurality of engagement tabs 30 projecting from the keyboard support 10, the respective one of the plurality of receiving wells 38 is provided in the keyboard 14.

For example, each one of the at least one receiving well 38 is configured to receive a respective at least one of the at least one engagement tab 30 when the keyboard 14 is supported on the keyboard support 10 such that movement of each one of the respective at least one of the at least one engagement tab 30 is opposed by the one of the at least one receiving well 38 which receives the respective at least one of the at least one engagement tab 30 when the keyboard 14 is supported on the keyboard support 10. For example, the above-described movement is limited. As a further example, the above-described movement is substantially prevented.

For example, each one of the at least one receiving well 38 is configured to receive a respective at least one of the at least one engagement tab 30 when the keyboard 14 is supported on the keyboard support 10 such that movement of each one of the respective at least one of the at least one engagement tab 30 is opposed by the one of the at least one receiving well 38 which receives the respective at least one of the at least one engagement tab 30, such that lateral movement of the keyboard housing 16 relative to the keyboard support surface 10 is thereby opposed when the keyboard 14 is supported on the support surface 10. For example, the above-described movement is limited. As a further example, the above-described movement is substantially prevented.

For example, each one of the at least one receiving well 38 is configured to receive a respective at least one of the at least one engagement tab 30 when the keyboard 14 is supported on the keyboard support 10 such that movement of each one of the respective at least one of the at least one engagement tab 30 is opposed by the one of the at least one receiving well 38 which receives the respective at least one of the at least one engagement tab 30, such that movement of the keyboard housing 16 relative to the support surface reference axis 200 is thereby opposed when the keyboard 14 is supported on the support surface 10. For example, the above-described movement is limited. As a further example, the above-described movement is substantially prevented.

For example, each one of the at least one receiving well 38 is configured to receive a respective at least one of the at least one engagement tab 30 when the keyboard 14 is supported on the keyboard support 10 such that movement of each one of the at least one of the at least one engagement tab 30 which is effected by an application of force to the keyboard 14 in a direction orthogonal to the support surface reference axis 200 is opposed by the one of the at least one receiving wells 38 which receives the respective at least one of the at least one engagement tabs 30 when the keyboard 14 is supported on the keyboard support 10. For example, the above-described movement is limited. As a further example, the above-described movement is substantially prevented.

For example, each one of the at least one receiving well 38 is configured to receive a respective at least one of the at least one engagement tab 30 when the keyboard 14 is supported on the keyboard support 10 such that each one of the at least one receiving well 38 is disposed in an interference fit relationship with the respective at least one of the at least one engagement tab 30.

For example, each one of the at least one engagement tab 30 is projecting from the keyboard 14, and wherein each one of the at least one receiving well 38 is provided in the keyboard support 10.

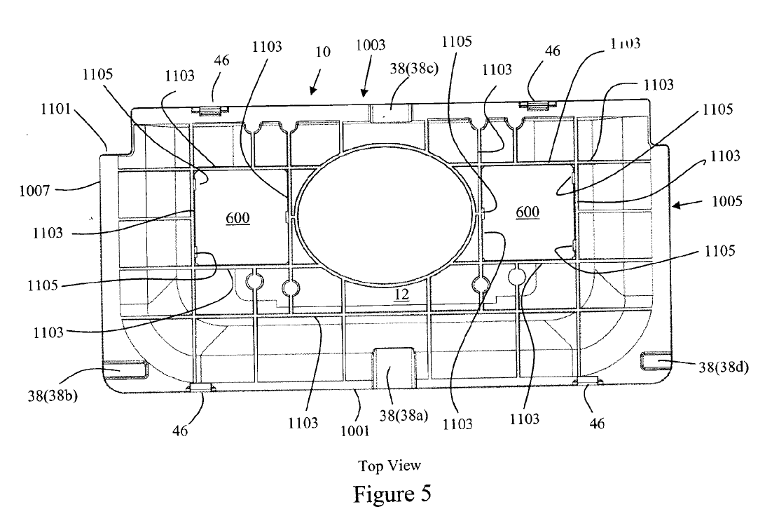

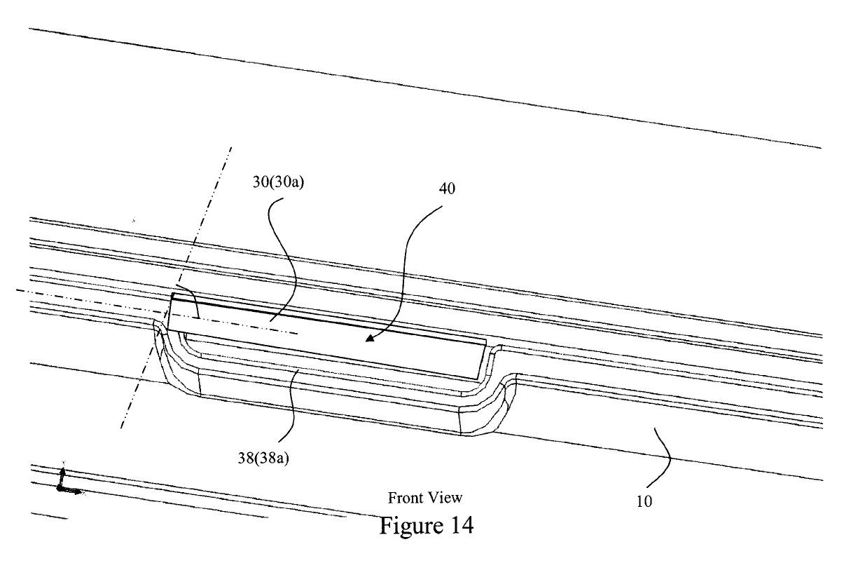

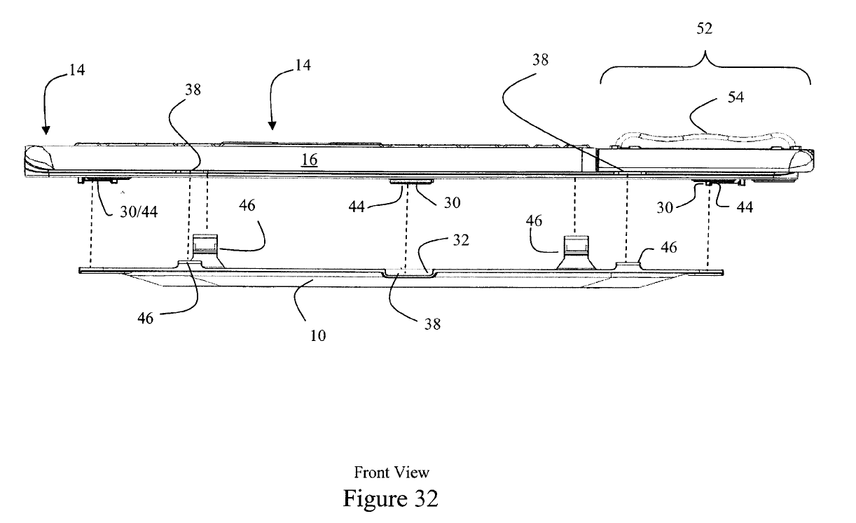

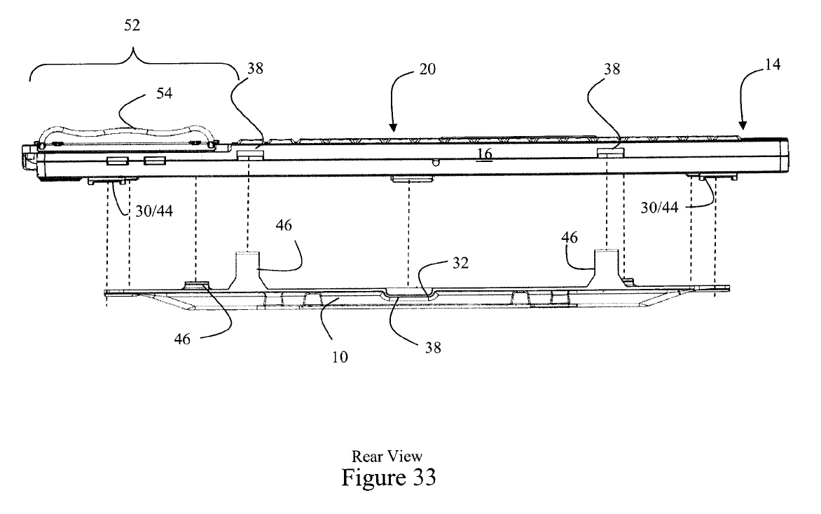

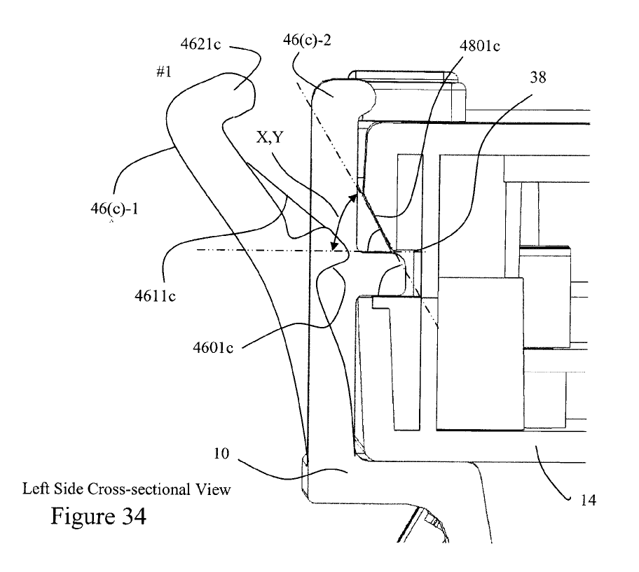

For example, in the illustrated embodiment, and referring to FIG. 22, there is provided four engagement tabs 30 (for the purpose of distinguishing between them, these are also identified with reference numerals 30a, 30b, 30c, and 30d) which depend from the keyboard 14. Tab 30a depends from a generally centrally located front portion of the keyboard 14. Tabs 30b, 30d depend from opposite side portions of the keyboard 14 and closer to the front of the keyboard. Tab 30d depends from a generally centrally located rear portion of the keyboard 14. For example, each one of the tabs 30 is in the form of a vulcanized rubber pad. Referring to FIG. 5, there is also provided four receiving wells 38 (for the purpose of distinguishing between them, these are also identified with reference numerals 38a, 38b, 38c, and 38d) in the keyboard support 10. Referring to FIGS. 32 and 33, each of the receiving wells 38 is configured to receive a respective one of the tabs 30 in an interference fit relationship when the keyboard 14 is supported on the keyboard support 10. The receiving of some of the retaining tabs 30 by some of the receiving wells 38 is illustrated in FIGS. 14, 15, 17.

### (B) Second Mode of Co-Operative Configuration of Keyboard and Keyboard Support for Opposing Movement of Keyboard Relative to Keyboard Support

A second mode of co-operative configuration of the keyboard 14 and the keyboard support 10 is provided.

The keyboard 14 and the keyboard support 10 are provided. The provided keyboard 14 includes the housing 16.

### First Aspect

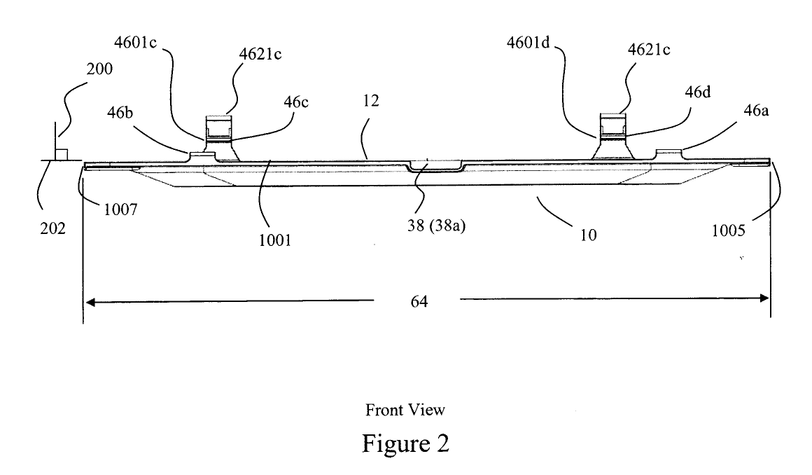

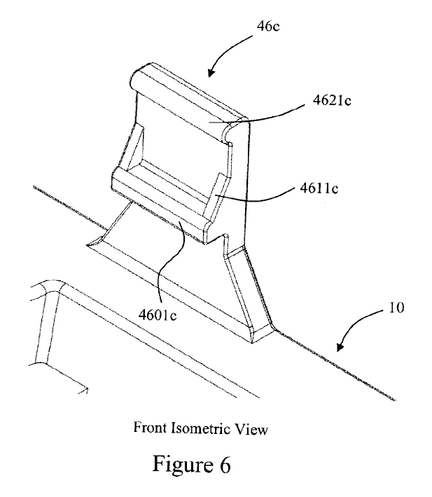

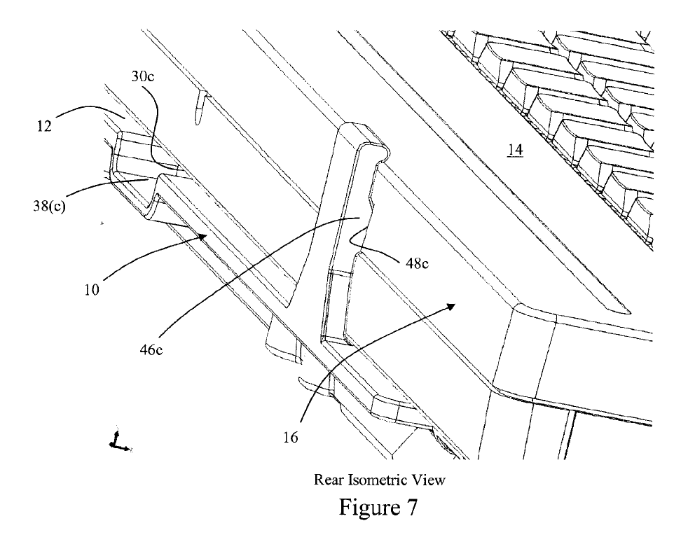

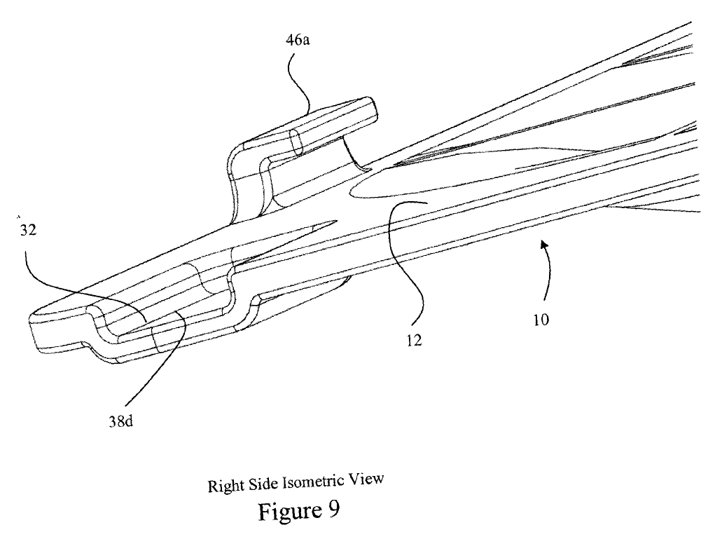

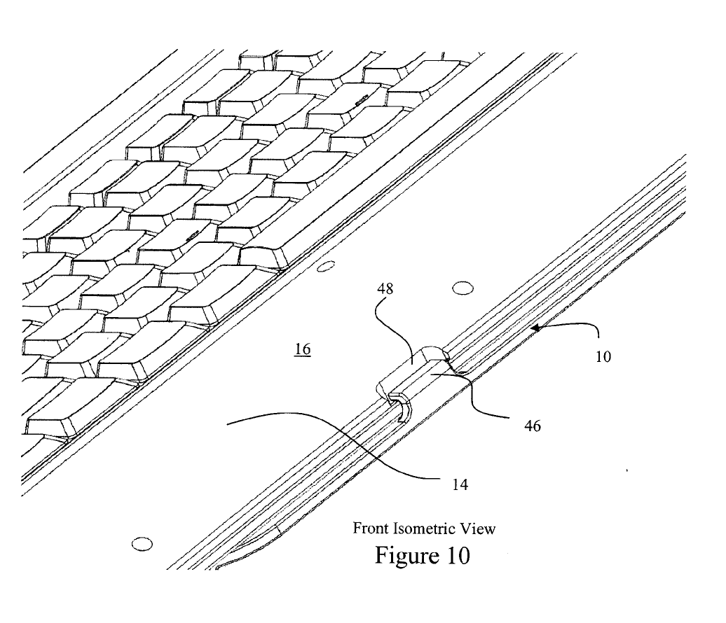

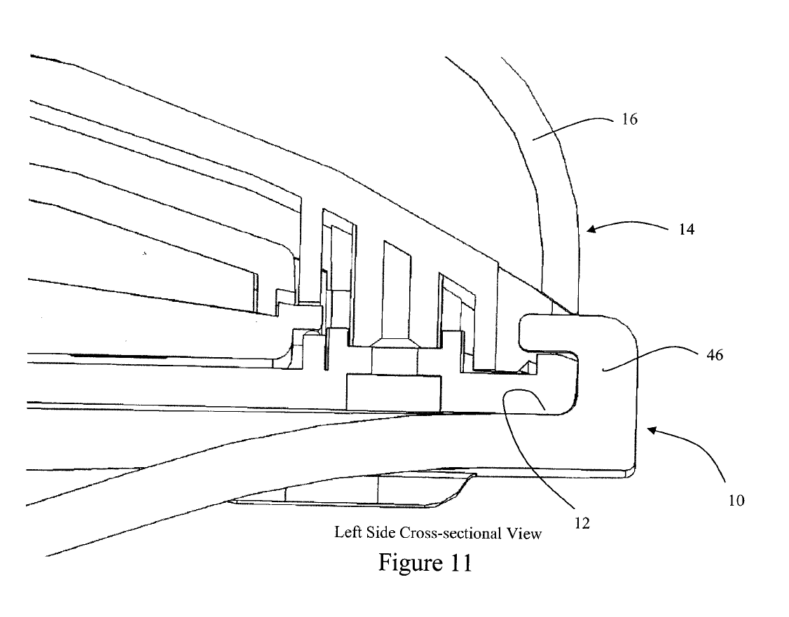

Referring to FIGS. 2 to 11, 32, and 33, in one aspect, the keyboard 14 is configured to be coupled to the keyboard support 10 by way of snap-fit engagement. In this respect, when coupled to one another, the keyboard 14 and the keyboard support 10 are coupled by way of snap-fit engagement.

For example, such coupling effects opposition to the movement of the keyboard housing 16 in substantially every direction relative to the keyboard support 10 when the keyboard 14 is supported on the keyboard support 10.

For example, with respect to the combination of the keyboard 14 and the keyboard support 12, there is further provided a retainer tab assembly 47, and a receiving assembly 49. The receiving assembly 49 is configured to receive the retainer tab assembly 47 when the keyboard 14 is supported on the keyboard support 10 so as to effect the coupling of the keyboard 14 to the keyboard support 10 when the keyboard 14 is supported on the keyboard support 10 such that movement of the keyboard housing 16 is opposed in substantially every direction relative to the keyboard support 10.

For example, the retainer tab assembly 47 includes at least one retainer tab 46, and the receiving assembly 49 including at least one recess 48. Each one of the at least one recess 48 is configured to receive a respective at least one of the at least one retainer tab 46 when the keyboard 14 is supported on the keyboard support 10, such that each one of the at least one of the at least one retainer tab 46 is configured to be received by a one of the at least one recess 48 when the keyboard 14 is supported on the keyboard support 10 such that movement of the keyboard housing 16 is opposed in substantially every direction relative to the keyboard support 10.

For example, each one of the at least one retainer tab 46 projects from any one of the keyboard 14, the keyboard support 10, or a combination thereof.

As a further example, for each one of the respective at least one of the at least one retainer tab 46 projecting from the keyboard 14 and configured to be received by a one of the at least one recesses 48 when the keyboard 14 is supported on the keyboard support 10, the one of the at least one recess 48 is provided in the keyboard support 10. For each one of the respective at least one of at least one retainer tab 46 projecting from the keyboard support 10 and configured to be received by a one of the at least one recess 48 when the keyboard 14 is supported on the keyboard support 10, the one of the at least one recess 48 is provided in the keyboard 14.

For example, each one of the at least one retainer tab 46 projects from the keyboard support 10, and wherein each one of the at least one recess 48 is provided in the keyboard 14.

For example, each one of the at least one retainer tab 46 corresponds to a respective one of the at least one recess 48, such that each one of the at least one retainer tab 46 is configured to be received by the respective one of the at least one recess 48 when the keyboard 14 is supported on the keyboard support 10 such that movement of the keyboard housing 16 is opposed in substantially every direction relative to the keyboard support 14.

### Second Aspect

In another aspect, the keyboard 14 and keyboard support 10 are co-operatively configured for coupling to one another such that, when the keyboard 14 is coupled to the keyboard support 10, movement of the keyboard housing 16 is opposed in substantially every direction relative to the keyboard support 10. In this respect, with respect to the combination of the keyboard 14 and the keyboard support 12, there is further provided a retainer tab assembly 47 and a receiving assembly 49. The receiving assembly 49 is configured to receive the retainer tab assembly 47 when the keyboard 14 is supported on the keyboard support 10 so as to effect coupling of the keyboard 14 to the keyboard support 10 such that the movement of the keyboard housing 16 is opposed in substantially every direction relative to the keyboard support 10 when the keyboard 14 is supported on the keyboard support 10.

For example, the retainer assembly 47 includes at least one retainer tab 46, and the receiving assembly 49 is configured to receive each one of the at least one retainer tab 46 when the keyboard 14 is supported on the keyboard support 10 so as to effect the coupling of the keyboard 14 to the keyboard support 10 such that movement of the keyboard housing 16 is opposed in substantially every direction relative to the keyboard support 10. As a further example, the receiving assembly 49 includes at least one recess 48, and each one of the at least one recess 48 is configured to receive a respective at least one of the at least one retainer tab 46 when the keyboard 14 is supported on the keyboard support 10 so as to effect the coupling of the keyboard 14 to the keyboard support 10 such that movement of the keyboard housing 16 is opposed in substantially every direction relative to the keyboard support 10, such that each one of the at least one retainer tab 46 is configured to be received by a one of the at least one of recess 48 when the keyboard 14 is supported on the keyboard 10.

As a further example, each one of the at least one retainer tab 46 projects from any one of the keyboard 14, the keyboard support 10, or a combination thereof.

As a further example, for each one of the respective at least one of the at least one retainer tab 46 projecting from the keyboard 14 and configured to be received by a one of the at least one recesses 48 when the keyboard 14 is supported on the keyboard support 10, the one of the at least one recess 48 is provided in the keyboard support 10. For each one of the respective at least one of at least one retainer tab 46 projecting from the keyboard support 10 and configured to be received by a one of the at least one recess 48 when the keyboard 14 is supported on the keyboard support 10, the one of the at least one recess 48 is provided in the keyboard 14.

For example, each one of the at least one retainer tab 46 projects from the keyboard support 10, and wherein each one of the at least one recess 48 is provided in the keyboard 14.

For example, each one of the at least one retainer tab 46 corresponds to a respective one of the at least one recess 48, such that each one of the at least one retainer tab 46 is configured to be received by the respective one of the at least one recess 48 when the keyboard 14 is supported on the keyboard support 10 such that movement of the keyboard housing 16 is opposed in substantially every direction relative to the keyboard support 10.

For example, the coupling of the keyboard 14 to the keyboard support 10 is effected by way of snap-fit engagement. In this respect, for example, at least one of the respective at least one of the at least one retainer tab 46 is configured to be disposed in a snap-fit relationship with a respective one of the at least one recess 48 which receives the respective at least one of the at least one retainer tab 46 when the keyboard 14 is supported on the keyboard support 10. As a further example, there is further provided a guide assembly 500 for facilitating the receiving of each one of the at least one of the respective at least one of the at least one retainer tab 46 configured to be disposed in a snap-fit relationship with a one of the at least one recess 48 which receives the respective at least one of the at least one retainer tab 46 when the keyboard 14 is supported on the keyboard support 10.

For example, in the illustrated embodiment, and referring to FIGS. 2 to 11, there is provided four retainer tabs 46 (for the purpose of distinguishing between them, these are also identified with reference numerals 46a, 46b, 46c, and 46d). Tabs 46a and 46b are disposed at front portions of the keyboard support 10. Tabs 46c and 46d are disposed at rear portions of the keyboard support 10. In parallel, there is provided four recesses 48 (for the purpose of distinguishing between them, these are also identified with reference numerals 48a, 48b, 48c, and 48d). Recesses 48a and 48b are provided at front portions of the keyboard 14. Recesses 48c and 48d are provided at rear portions of the keyboard. Referring to FIGS. 32 and 33, each one of the retainer tabs 46a, 46b, 46c, and 46d is configured to be received by a respective one of the recesses 48a, 48b, 48c, and 48d. Coupling of the keyboard 14 to the keyboard support 12 is effected by insertion of the retainer tabs 46 into the corresponding recesses 48. Referring to Figures As a first step, the tabs 46a, 46b are inserted within the recesses 48a, 48b, respectively, to effect an interference fit between each one of the tabs 46a, 46b and a respective one of the recesses 48a, 48b. Each one of the tabs 46c, 46d is then bent rearwardly to permit the rear portion of the keyboard 14 to be lowered relative to the support surface 12 and thereby effect alignment between an operative protrusion 4601c, 4601d of each one of the tabs 46c, 46d and a respective one of the recesses 48c, 48d. For example, each one of the retainer tabs 46c, 46d includes a respective one of the guide 4611c, 4611d for guiding movement of the keyboard 14 towards a respective one of the recesses 46c, 46d. For example, each one of the guides 4611c, 4611d presents a guide surface disposed at an angle X relative to the horizontal when the keyboard support is disposed on a horizontal surface. For example, the angle X at which the guide surface is disposed at is about 65 degrees relative to the horizontal when the keyboard support 10 is disposed on a horizontal surface. In co-operation, each one of the recesses 46c, 46d extends from an external surface of the keyboard 14 and is defined by a respective one of upper recess surfaces 4801c, 4801d disposed at an angle Y relative to the horizontal when the keyboard support 10 is disposed on a horizontal surface. For example, the angle Y at which each one of the upper recess surfaces 4801c, 4801d is disposed at is about 65 degrees relative to the horizontal when the keyboard support 10 is disposed on a horizontal surface. This facilitates alignment of each one of the recesses 46c, 46d with the respective one of the protrusions 4601c, 4601d.

Once alignment is effected, the tabs 46c, 46d are released. By virtue of their resiliency, releasing the tabs 46c, 46d effects return of the tabs 46c, 46d to substantially their original condition. As a necessary incident, this causes the tabs 46c, 46d to move forwardly relative to the keyboard 14, and effect insertion of each one of the tabs 46c, 46d into a respective one of the recesses 48c, 48d, thereby effecting snap fit engagement of each one of the tabs 46c, 46d with a respective one of the recesses 48c, 48d.

Each one of the tabs 46c, 46d projects upwardly and is disposed vertically above a plane tangent to the upper surface of the key area 20 and rearwardly relative to the keyboard 14 when the keyboard 14 is supported by and coupled to the keyboard support 10. The vertical and lateral disposition of the tabs 46c, 46d, relative to the keyboard 14, when the keyboard 14 is supported by and coupled to the keyboard support 10, effects a guard functionality, such that the tabs 46c, 46d function as guards, limiting or preventing contact between the desk of the workstation with the key area 20 of the keyboard 14 when the keyboard-keyboard support combination is moved towards the desk by effecting rearward movement of the multi-position adjustable keyboard supporting mechanism 68 relative to the desk. The contact is limited or prevented because the tabs 46c, 46d are configured to contact the desk before contact is made by the keyboard 14 by virtue of the vertical and lateral disposition of the tabs 46c, 46d relative to the keyboard. Each one of the tabs 46c, 46d also includes a respective one of the overhangs 4621c, 4621d for further limiting vertical displacement of the keyboard 14 relative to the keyboard support surface 10.

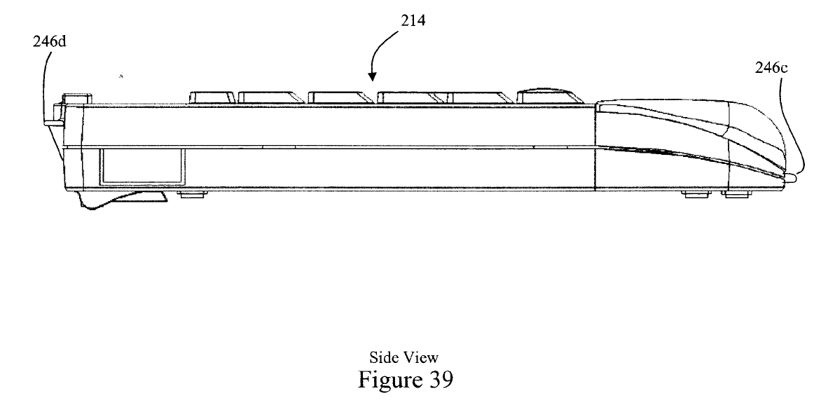

A second embodiment of a keyboard, identified with reference numeral 214a, is illustrated in FIG. 39. Unlike the keyboard 14, keyboard 214a includes retainer tabs 246b, 246d configured for being received within corresponding recesses provided in a corresponding second embodiment of a keyboard support. In this respect, it is intended to illustrate that the retainer assembly or the retaining tabs are not required to be disposed on the keyboard support, and that the retainer assembly or the retaining tabs could be disposed on the keyboard and that corresponding recesses could be provided in the keyboard support to effect a snap-fit coupling of the keyboard to the keyboard support.

### Third Aspect

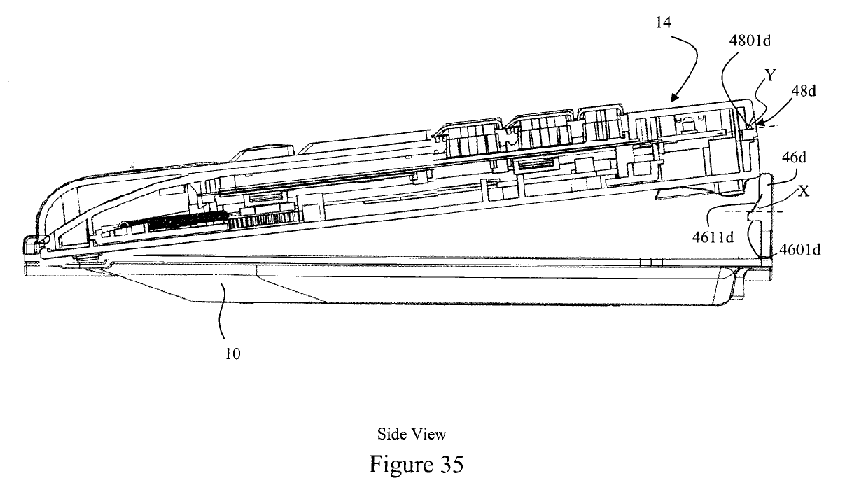

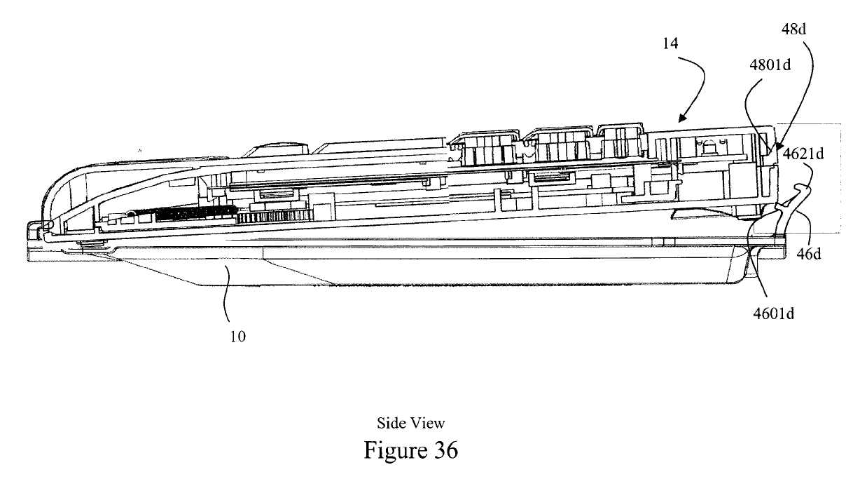

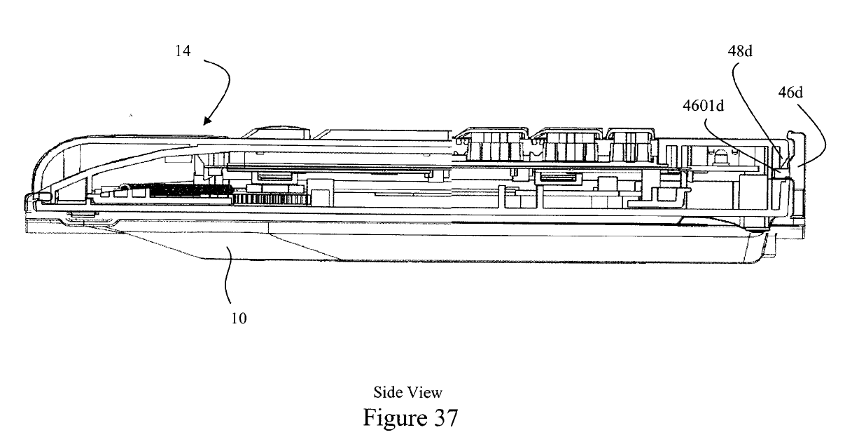

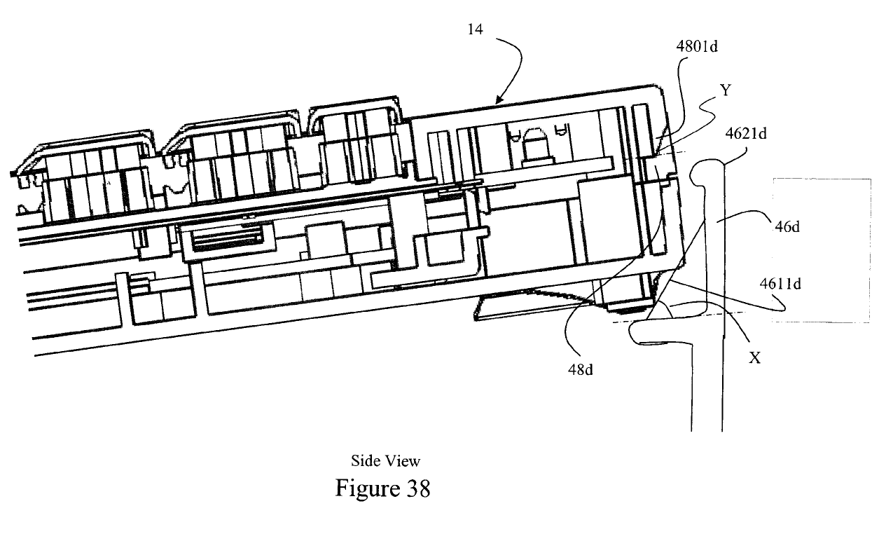

In this respect, and referring to FIGS. 35 to 38, there is provided a method of attaching a keyboard 14 to a keyboard support 10.

The method includes providing a keyboard 14 including a receiving assembly including a first recess 48b provided in a first keyboard surface portion 1401 of the keyboard 14 and a second recess 48c provided in a second keyboard surface portion 1403 of the keyboard 14, wherein the second keyboard surface portion 1403 is disposed opposite to the first portion 1401.

A keyboard support 10 is also provided and includes a support surface 12 configured for supporting the keyboard 14 and also includes a retainer tab assembly. The retainer tab assembly includes a first retainer tab 46b and a second retainer tab 46c. The first retainer tab 46c projects from a first keyboard support surface portion 1201, and includes a protrusion 4601c configured for insertion into the first recess 1401. The second retainer tab 46d projects from a second keyboard support surface portion 1203 and includes a protrusion 4601d configured for insertion into the second recess 1403. The second retaining tab 46c includes resilient material for facilitating bending of the second retaining tab 46c.

The protrusion 4601c of the first retaining tab 46b is inserted into the first recess 1401 of the keyboard 14. The second retaining tab 46c is then bent out of the way of the keyboard 14 and, more particularly, the second keyboard surface portion 1203. This permits the keyboard 14 to be lowered relative to the support surface 12 and thereby effect alignment of the projection 4603 of the second retaining tab 46c with the second recess 1403. For example, the retainer tab 46c includes a guide 4611c for guiding movement of the keyboard 14 towards the recess 46c. For example, the guide 4611c presents a guide surface disposed at an angle X relative to the horizontal when the keyboard support is disposed on a horizontal surface. For example, the angle X at which the guide surface is disposed at is about 65 degrees relative to the horizontal when the keyboard support is disposed on a horizontal surface. In co-operation, the recess 46c extends from an external surface of the keyboard 14 and is defined by an upper recess surface disposed at an angle Y relative to the horizontal when the keyboard support is disposed on a horizontal surface. For example, the angle Y at which the upper recess surface is disposed at is about 65 degrees relative to the horizontal when the keyboard support is disposed on a horizontal surface. This facilitates alignment of the recess 46c with the protrusion 4601c.

Once alignment is effected, the tab 46c is released from the deformed condition it has assumed after having been caused to have been bent. By virtue of its resiliency, releasing the tab 46c effects a return of the tab 46c towards its original condition prior to the deformation caused by the bending. As a necessary incident, this causes the tab 46c to move forwardly relative to the keyboard 14, and effect insertion of a respective projection 4601c of each one of the tabs 46c into a respective one of the recesses 48c thereby effecting snap fit engagement of each one of the tabs 46c with a respective one of the recesses 48c.

(C) Keyboard with Retainer for Limiting Mouse Travel

In another aspect, and referring to FIGS. 12, 16, 23 to 25, there is provided the keyboard 14 including the key section 18, wherein the key section 18 includes a plurality of keys 80, a mousepad section 52 including the mousepad surface 24, and a mouse retainer 54 disposed peripherally relative to the mousepad surface 24. When a mouse device 56 is disposed on a portion of the mousepad surface 24, and the disposition of the portion of the mousepad surface 24 is substantially horizontal, and the keyboard 14 is then re-positioned so that the portion of the mousepad surface 24 becomes disposed at a sufficient angle relative to the horizontal such that gravitational force effects movement of the mouse device 56, the mouse device 56 is prevented from sliding off the keyboard 14 by the mouse retainer 54.

For example, with respect to the keyboard 14, the keyboard 14 includes a front end 58 and a rear end 60, wherein the mouse retainer 54 is disposed rearwardly relative to the mousepad surface 24. When the mouse device 56 is disposed on a portion of the mousepad surface 24, and the disposition of the portion of the mousepad surface 24 is substantially horizontal, and the keyboard 14 is then tilted so that the front end 58 is disposed at a sufficiently higher vertical position relative to the rear end 60 (see FIG. 19) such that gravitational force effects movement of the mouse device 56 in the rearward direction, the mouse device 56 is prevented from sliding off the rear end 60 of the keyboard 14 by the mouse retainer 54.

For example, with respect to the mouse retainer 54, the mouse retainer 54 extends substantially across the rear edge 62 of the mousepad surface 24.

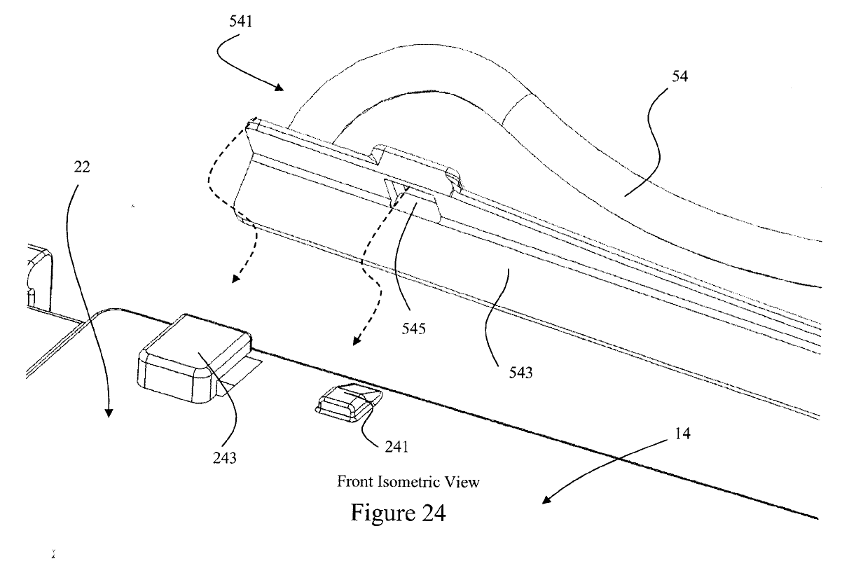

For example, the retainer 54 is provided as part of a rail assembly 541 which coupled to the keyboard housing 16 by snap-fit engagement. For example, and referring to FIG. 24, the rail assembly 541 is provided including a retainer rail 54 extending from a mounting structure 543. The mounting structure 543 includes a retention cavity 545 configured for becoming disposed in snap-fit engagement with a footpad 241 provided on the keyboard 14. A slotted guide 243 is also provided on the keyboard 14, and is configured to receive and vertically retain the mounting structure 543 as the cavity 545 is being snap-fit over the footpad 241.

### (D) Compact Keyboard-Keyboard Support Combination

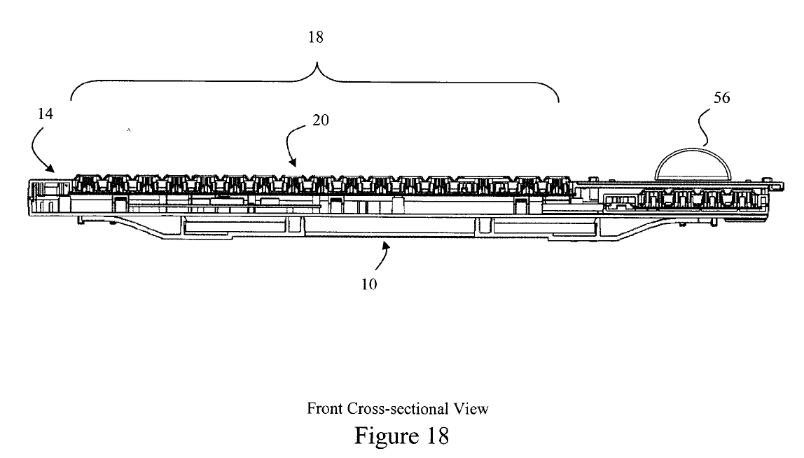

Referring to FIGS. 2, 12, 16, and 18, there is provided a keyboard-keyboard support combination including a key section 18 including a QWERTY key arrangement 20 and the mousepad surface 24. The QWERTY key arrangement 20 includes at least fifty (50) keys 80. For example, the minimum width of each of the keys is at least about 0.4 inches. For example, the minimum width is about 0.71 inches.

The maximum width 64 of the keyboard support 10 is less than about 19 inches. For example, with respect to the maximum width 64, the maximum width 64 of the keyboard support 10 is less than about 17 inches. For example, the maximum width 64 is about 16 inches.

In another aspect, the keyboard-keyboard support combination having this compact functionality is provided in a workstation assembly 28. In this respect, a workstation assembly 28 is provided including a workstation 26, and the keyboard-keyboard support combination coupled to the workstation 26, wherein the keyboard 14 is supported by the keyboard support 10.

In another aspect, the keyboard 14 includes the QWERTY key arrangement 20 including at least 50 keys and the mousepad surface 24.

### (E) Mounting Functionality of Keyboard Support

Referring to FIGS. 1, and 19 to 11, there is provided a keyboard support configured for receiving and attaching to a mounting plate of a mounting plate 66 of the mechanism 68, comprising a recessed mounting surface corresponding to the mounting plate 66 of the mechanism 68, wherein the recessed mounting surface is configured to receive the mounting plate 66 and effect coupling of the mounting plate 66 to the mounting surface. For example, the keyboard support 10 is supporting a keyboard 12. As a further example, the keyboard support is coupled to the mounting plate 66.

There is further provided a keyboard support 10 which is configured for receiving and attaching to a mounting plate 66 of any one of a plurality of keyboard mounting mechanisms 68. Each one of the plurality of keyboard mounting mechanisms 68 is configured for coupling to a workstation 26. A respective mounting plate 66 of one of the plurality of keyboard mounting mechanisms 68 is shaped differently relative to a respective mounting plate 66 of each one of the other ones of the plurality of keyboard mounting mechanisms 68. The keyboard support 10 comprises a plurality of recessed mounting surfaces 70, wherein each one of the plurality of recessed mounting surfaces 70 corresponds to a respective one of the plurality of keyboard mounting mechanisms 68, and wherein each one of the plurality of recessed mounting surfaces 70 is configured to receive a respective mounting plate 66 of a respective one of the plurality of keyboard mounting mechanisms 68. For example, with respect to the relationship between at least one of the plurality of recessed mounting surfaces 70 and at least one other one of the plurality of recessed mounting surfaces 70, at least one of the plurality of recessed mounting surfaces 70 is at least partially co-located with at least one of the other ones of the plurality of recessed mounting surfaces 70.

For example, the keyboard support 10 includes two recessed mounting surfaces 70 disposed on a lower surface 72 of the keyboard support 10. The recessed mounting surface 70 is configured for attachment to the mounting plate of any one of Anatome™ Model CA300HG, Anatome™ Model CA200, Anatome™ Model CA100, or Anatome™ Model WallTrax #1602. Bolt holes 74 are provided in the recessed mounting surface 70 so as to effect attachment of the mounting plate of any of the above-described Anatome™ products to the recessed mounting surface 70 by way of bolts 76. The recessed mounting surface 70 is configured for attachment to the Humanscale™ Model 5G keyboard support mechanism. Bolt holes 74 are provided in the recessed mounting surface 70 so as to effect attachment of the mounting plate of the Humanscale™ Model 5G to the recessed mounting surface 70 by way of bolts 76.

In one aspect, the keyboard support 10 is configured for supporting a keyboard 14 at a workstation 26. In this respect, there is provided a workstation system including a workstation 26, a keyboard mounting mechanism 68 configured for coupling to the workstation 26 and including a mounting plate 66, a keyboard 14, and a keyboard support 10 configured for receiving and attaching to the mounting plate 66. The keyboard support 10 includes a recessed mounting surface 70 configured for receiving the mounting plate 66, and also including a support surface 12 configured for supporting the keyboard 14. The keyboard 14 is also configured for receiving and attaching to a mounting plate 66 of any one of at least one other keyboard mounting mechanism 68. Each one of the at least one other keyboard mounting mechanism 68 is configured for coupling to the workstation 26. A respective mounting plate 66 of a one of the combination of the keyboard mounting mechanism 68 and the at least one other keyboard mounting mechanism 68 is shaped differently relative to a respective mounting plate 66 of each one of the other ones of the combination of the keyboard mounting mechanism 68 and the at least one other keyboard mounting mechanism 68. The keyboard support 10 further includes at least one other recessed mounting surface 70, wherein each one of the at least one other recessed mounting surface 70 corresponds to a respective one of the at least one other keyboard mounting mechanism 68. Each one of the at least one other recessed mounting surface 70 is configured to receive a respective mounting plate 66 of a respective one of the at least one other keyboard mounting mechanism 68. For example, with respect to the relationship between the recessed mounting surface 70 and at least one of the at least one other recessed mounting surface 70, the recessed mounting surface 70 is at least partially co-located with at least one of the at least one other recessed mounting surface 70.

A workstation assembly 28 is formed by mounting the keyboard support 10, including the above-described mounting functionality, to a workstation 26 with a mounting mechanism, such as mechanism 68.

### (F) Substantially Deterministic Ergonomic Positioning of Mousepad Surface 24

Referring to FIGS. 12 and 16, there is provided a keyboard-keyboard support combination, including a keyboard support 10 and a keyboard 14. The keyboard support 10 is configured for coupling to the keyboard 14, and includes a support surface 12 configured for supporting the keyboard 14, such that a reference axis 34 is defined by an axis which is normal to a plane 36 tangent to at least a portion of the support surface 12. The keyboard 14 includes a housing 16. The keyboard 14 and keyboard support 10 are co-operatively configured such that movement of the keyboard housing 16 relative to the keyboard support 12 is opposed when the keyboard 14 is supported on the keyboard support 10. The keyboard 14 further includes a QWERTY key area 20 including at least fifty (50) keys 80, and a mousepad 22 including a mousepad surface 24.

Referring to FIG. 16, the minimum horizontal distance 78 between: (i) the space between the “G” and “H” keys, and (ii) a vertical plane 82 tangent to an edge 84 of the mousepad surface 24, is from about 5 inches to about 10 inches. For example, this minimum horizontal distance is from about 5 inches to about 9 inches. For example, this minimum horizontal distance is about 7.8 inches.

For example, with respect to the relationship between the keyboard 14 and the keyboard support 10, the keyboard 14 and keyboard surface are further co-operatively configured such that, when the keyboard 14 is coupled to the keyboard support 10 and supported by the support surface 12, and a force is applied to the keyboard housing 16 in an orthogonal direction relative to the reference axis 34, movement of the keyboard housing 16 is relative to the keyboard support 10.

For example, with further respect to the relationship between the keyboard 14 and the keyboard support 10, the keyboard includes an engagement assembly 40; and the keyboard support 10 includes a retainer assembly 42, wherein the engagement assembly 40 is configured such that, when the keyboard 14 is coupled to the keyboard support 10 and supported by the support surface 12, the engagement assembly 40 co-operates with the retainer assembly 42 such that lateral movement of the keyboard housing 16 relative to the keyboard support 10 is opposed.

For example, with further respect to the relationship between the keyboard 14 and the keyboard support 10, the keyboard housing 16 includes an engagement tab assembly 40; and the keyboard support 10 includes a engagement surface assembly 42, wherein the engagement tab assembly 40 is configured to co-operate with the engagement surface assembly 42 such that movement of the keyboard housing 16 relative to the keyboard support is opposed when the keyboard 14 is supported on the support surface 10.

For example, with further respect to the relationship between the keyboard 14 and the keyboard support 10, the keyboard housing 16 includes an engagement tab assembly 40; and the keyboard support 10 includes a receiving well assembly, wherein the receiving well assembly is configured to receive the engagement tab assembly when the keyboard 14 is supported on the keyboard support. Further aspects of the engagement tab assembly 40 and the receiving well assembly are discussed above.

In one aspect, the keyboard 14 is coupled to the keyboard support 10 to form a coupled unit.

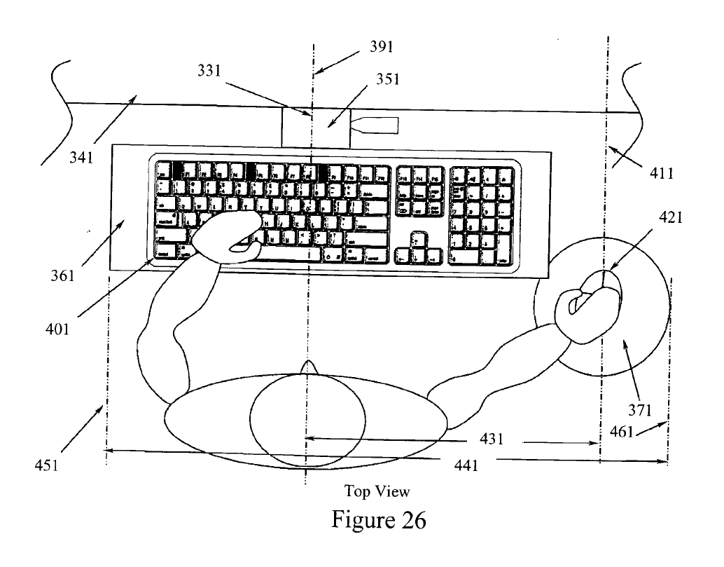

In another aspect, the keyboard support 10, being coupled to and supporting the keyboard 14, is coupled to a workstation 26 to form a workstation assembly 28. FIG. 26 shows a conventional keyboard on keyboard tray/mousepad configuration. The mechanism 68 is attached by way of a track system under the desk 341. There are several ergonomic issues with this layout. The distance 431 between center line 331 and 411 denotes the user having to over-reach for the mouse 421 due to the location of the mousepad 371 to the far right of the user. This mousepad location is due to the very long keyboard tray 361 and the fact that the conventional keyboard 401 does not have provision for a mousepad. The stretching position of the user's right arm typically causes chronic pain in wrist, elbow, shoulder and neck. As well, the user's posture is thrown off which typically causes improper back positioning and possible chronic back pain.

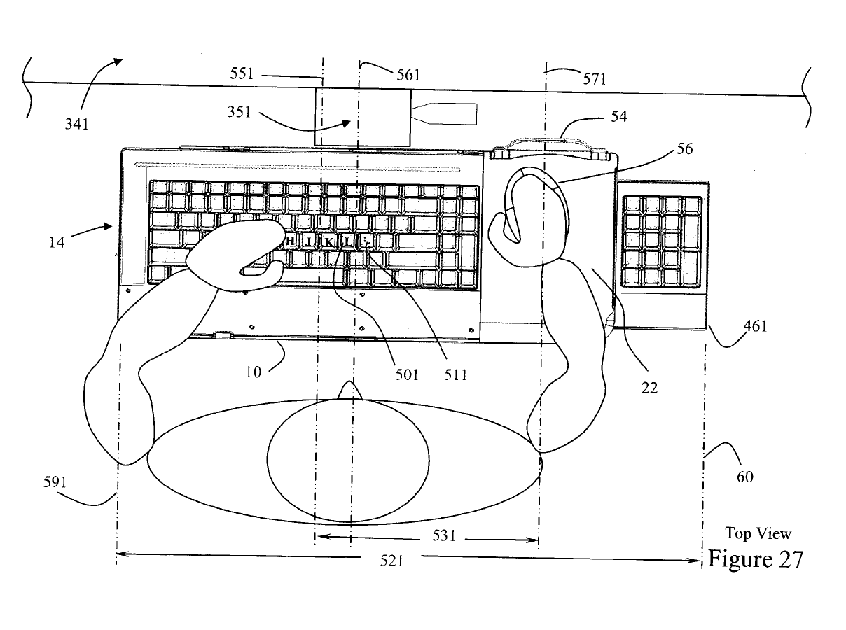

FIG. 27 shows the user's improved positioning with the introduction of the keyboard 14 and keyboard support 10 combination (hereinafter “the combination”). The user is more centered in front of the QWERTY key area, the actual center being 561 between the “L” key 501 and the “;” key 511. To this, the distance 531, measured from the center line 551 to mousepad centerline 571 is a much smaller distance as compared to distance 431 in FIG. 26 with the conventional arrangement. The user is in a comfortable, neutral position with the right arm more naturally bent at the elbow. This greatly reduces the strain placed on all critical points including neck, shoulder, elbow, forearm and wrist.

The overall length, and therefore footprint, is significantly less with the combination shown in FIG. 27 as compared to the conventional tray/keyboard arrangement shown in FIG. 26. The overall length 521, measured from 591 to 601 includes the keyboard 14, mousepad 22 and numeric keypad 461 (this embodiment of the keyboard includes a retractable and nestable numeric keypad) in the OUT position. This distance is much less than that of 441 shown in FIG. 26, measured between 451 and 461. This reduction in required length can equate to significant savings in the corporate world, whereby more workstations can be added to the office floor plan.

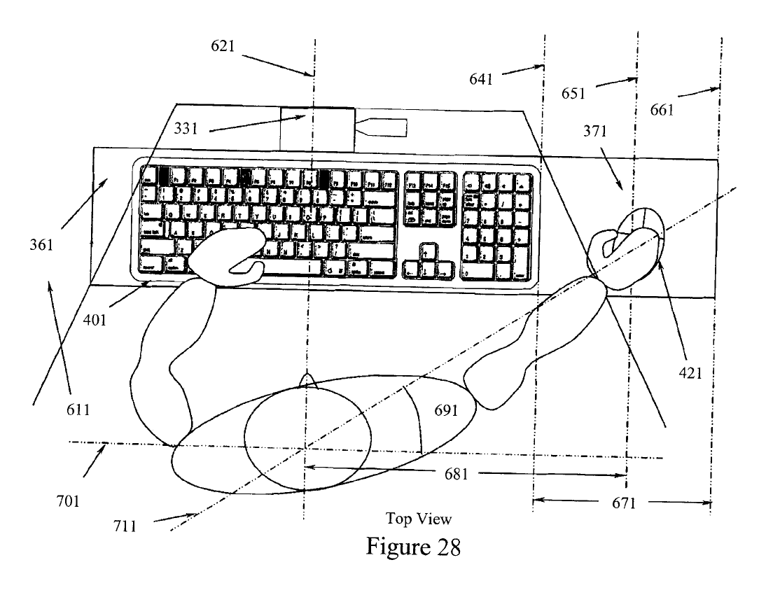

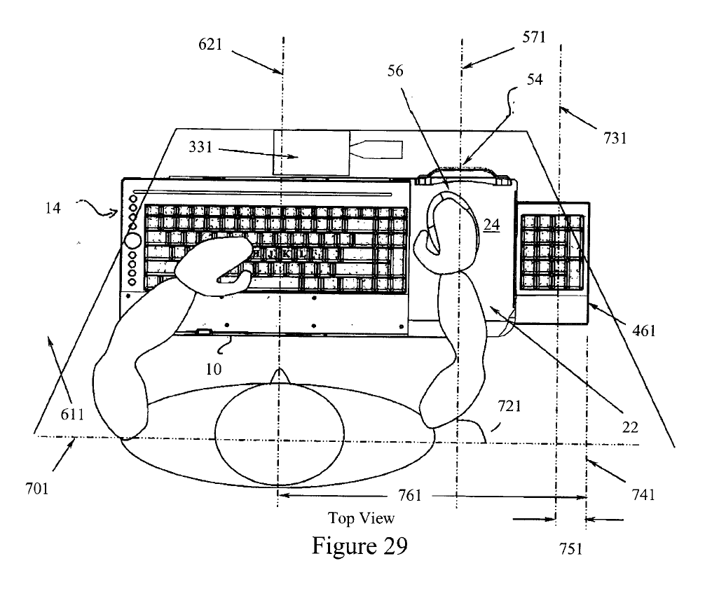

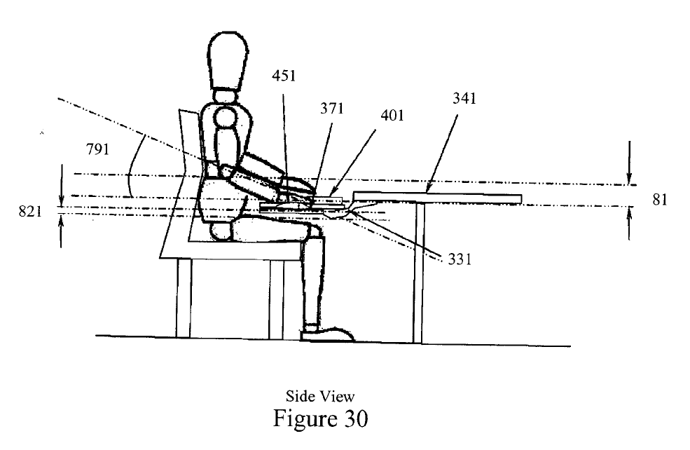

FIG. 28 shows another scenario often seen in an office environment—the corner desk 611. This poses challenge to the conventional tray/keyboard/mousepad arrangement due to the overall length 441 seen in FIG. 26. The distance 671, measured between 641 and 661, denotes the part of the keyboard and mousepad that ends up under the corner desk arrangement. This forces the user to reach underneath desk to access the mouse, thereby either dropping their shoulder or pronating their right to an angle 791 seen in FIG. 30, both undesirable actions resulting in chronic pain. FIG. 29 shows the distance under desk 611 denoted by 751, measured between 731 and 741, which is significantly less than the distance 671 as seen in FIG. 28. The strain placed on the user's right shoulder and wrist are eliminated and in a more natural, neutral position/posture. Access to both mouse 56 and numeric keypad 461 is greatly improved.

Also shown in FIG. 28 is the position of the mousepad 371 directly beside the keyboard tray 36. Keyboard trays like these in the market are sold with the integrated mousepad. This position of the mouse causes the user to stretch the right shoulder and arm in order to reach the mouse 421. This stretching action causes the angle 691, as measured between the lines 701 and 711. The user's torso becomes twisted, which causes undue strain on the spine and neck. In FIG. 29, this strain is eliminated by the close proximity of the mousepad 22 to the user. The user's posture is corrected whereby the angle 691, in FIG. 28, is brought to a perpendicular 90° angle which creates a natural, neutral posture and eliminates strain on all critical points. Also, the user's torso is no longer twisted, thus reducing strain on spine and neck.

FIG. 30 shows the conventional tray/keyboard arrangement from a side view perspective. The lower level position of the mousepad 371, as measured by 811, in relation to the keyboard tray and/or keyboard (depending on the vendor offering configuration) causes the user's wrist to pronate to an angle denoted by 791. This results in undue strain placed on the right wrist and can lead to chronic paid. Also, because of the tray/keyboard arrangement's overall thickness, the legroom beneath the tray 821 is typically inadequate for the user. More importantly, it restricts the user in terms of the height setting of the tray in relation to the user's height. This is especially an issue for shorter users that need the tray be set in a very low position but can't do this because their legs hit the underside of the tray before the optimal setting is achieved.

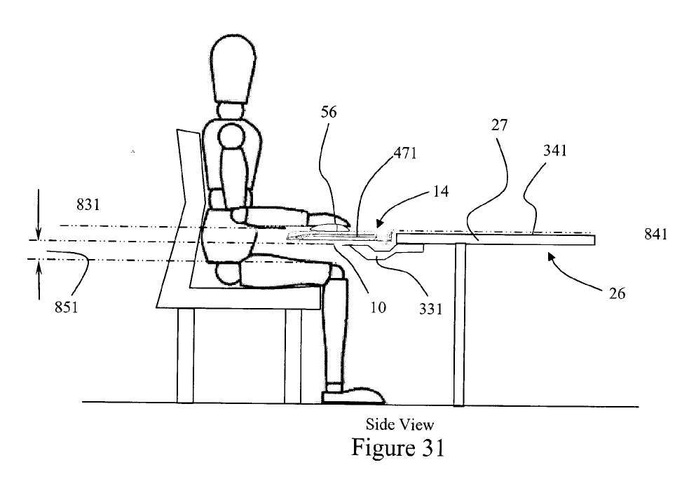

FIG. 31 shows the above-described combination. With the tray mechanism 68 set to the proper height, the user's arm is bent at a natural, neutral 90° angle. In this position, the user's wrist is completely straight, with the pronation angle completely eliminated, as denoted by 831 and therefore the potential for chronic wrist pain is eliminated. Also in FIG. 31, the combination addresses the legroom issue seen in FIG. 30. This is made possible by the thinner profile of the combination since the tray is eliminated and the integrated mousepad 22 is the same height as the keyboard. This results in a greater legroom 851 and more setting options for the user, especially the shorter user.

For example, the mousepad surface 24 is disposed in substantially the same plane as an upper surface of the key area 20.

### (G) Ballast Provided in Keyboard Support

Referring to FIG. 5, a ballast assembly is provided to contribute additional weight to the keyboard support 12.

The keyboard support 10 includes a plastic support assembly 1101, including the support surface 12 configured for supporting the keyboard 14. For example, the plastic support assembly 1101 includes a plurality of reinforcement ribs 1103.

A ballast assembly is provided including at least one ballast 600. For example, in the embodiment illustrated in FIG. 5, the ballast assembly includes two ballasts 600. Each one of the at least one ballast 600 is coupled to the plastic support assembly 1101. The ballast assembly is provided to contribute additional weight to the keyboard support 10, so that the keyboard support 10 can be mounted to and used with available multi-position adjustable keyboard supporting mechanisms 68 which have a tendency to. In this respect, a ballast can be provided such that the keyboard support includes at least about 25 weight percent of the at least one ballast based on the total weight of the keyboard support. In another respect, the provided ballast is a metal ballast, such as a steel ballast.

For example, with respect to the coupling of each one of the at least one ballast 600 to the plastic support assembly 1101, each one of the at least one ballast is coupled to the plastic support assembly by way of snap fit engagement. For example, the snap-fit engagement is effected between opposing reinforcement ribs 1103 of the plastic support assembly 1101. For example, the reinforcement ribs 1103 include tapered guides 1105 for guiding each of the at least one ballast 600 into snap fit engagement with the reinforcement ribs 1103.

### (H) Thickness of Keyboard-Keyboard Support Combination

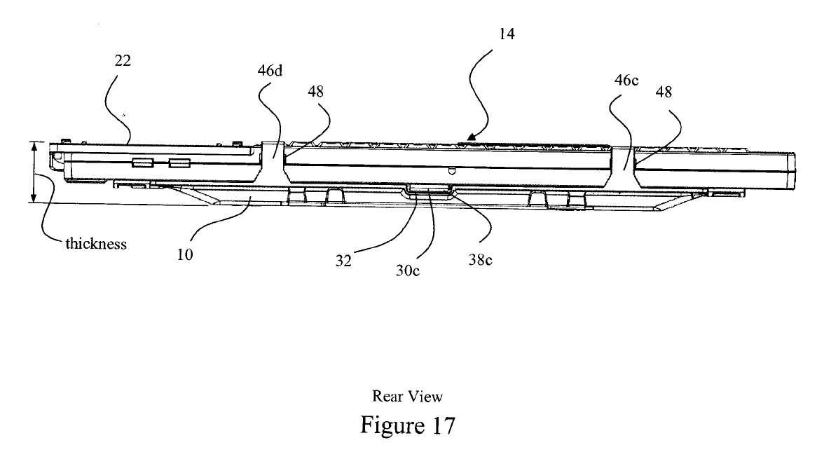

Referring to FIG. 17, there is provided a combination of the keyboard 14 and the keyboard support 10. The keyboard 14 is supported on the keyboard support 10. The maximum thickness of the combination of the keyboard support and the supported keyboard is less than about 2 inches. For example, the thickness is 1.69 inches.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

1-105. (canceled)

106. A keyboard support for securing a keyboard to an underlying structure, said keyboard support comprising:
a body having a keyboard receiving face opposite a mounting face;
said body having keyboard engaging means for registering with corresponding keyboard support engaging means on said keyboard to immoveably secure said keyboard to said keyboard receiving face of said keyboard support;
said mounting face configured to register in an underlying support structure;
said body further including fastener engaging means for securement of said body to said underlying structure.

107. The keyboard support of claim 106 wherein said keyboard engaging means and said keyboard support engaging means are selected from the group consisting of tabs and sockets.

108. The keyboard support of claim 107 further comprising a mounting plate secured to said body opposite said keyboard receiving face wherein said mounting face is on said mounting plate.

109. They keyboard support of claim 108 wherein said mounting plate comprises a plurality of said fastener engaging means arranged to register with corresponding fastener engaging means of different of said underlying support structures.

110. They keyboard support of claim 109 wherein said keyboard engaging means and said keyboard support engaging means are releaseably engaging.

111. The keyboard support of claim 110 wherein said keyboard engaging means are tabs and said keyboard support engaging means are sockets formed into housing of said keyboard.

112. The keyboard support of claim 111 wherein at least some of said tabs are resiliently bendable to effect release of said keyboard from said keyboard support.
